(19) United States
(12) Patent Application Publication
(10) Pub. No.: US 2021/0297688 A1
(43) Pub. Date: Sep. 23, 2021

(54) WEIGHTED PREDICTION METHOD FOR MULTI-HYPOTHESIS ENCODING AND APPARATUS

(71) Applicant: HUAWEI TECHNOLOGIES CO., LTD., SHENZHEN (CN)

(72) Inventors: Weiwei XU, Hangzhou (CN); Haitao YANG, Shenzhen (CN); Yin ZHAO, Hangzhou (CN)

(21) Appl. No.: 17/338,896

(22) Filed: Jun. 4, 2021

Related U.S. Application Data
(63) Continuation of application No. PCT/CN2019/123828, filed on Dec. 6, 2019.

(30) Foreign Application Priority Data
Dec. 6, 2018 (CN) 201811490352.4
Dec. 7, 2018 (CN) 201811496427.X
Mar. 30, 2019 (CN) 201910260922.9

(51) Int. Cl. H04N 19/50; H04N 19/105; H04N 19/159; H04N 19/176

(52) U.S. Cl. CPC H04N 19/50; H04N 19/176; H04N 19/159; H04N 19/105

(57) ABSTRACT

This application provides a weighted prediction method for multi-hypothesis encoding and an apparatus. The method includes: determining a first target prediction block of a to-be-processed picture block based on an inter prediction mode; determining a second target prediction block of the to-be-processed picture block based on an intra prediction mode; determining, based on indication information in a bitstream, weight coefficients respectively corresponding to the inter prediction mode and the intra prediction mode; and weighting a pixel value of the first target prediction block and a pixel value of the second target prediction block based on the weight coefficients, to obtain a prediction value of the to-be-processed picture block. Implementation of this application improves prediction accuracy of a pixel value of a picture block and encoding/decoding performance to some extent.

### CROSS-REFERENCE TO RELATED APPLICATIONS

This application is a continuation of International Application No. PCT/CN2019/123828, filed on Dec. 6, 2019, which claims priority to Chinese Patent Application No. 201811490352.4, filed on Dec. 6, 2018 and Chinese Patent Application No. 201811496427.X, filed on Dec. 7, 2018 and Chinese Patent Application No. 201910260922.9, filed on Mar. 30, 2019, all of which are hereby incorporated by reference in their entireties.

### TECHNICAL FIELD

The present disclosure relates to the field of video encoding/decoding, and in particular, to a weighted prediction method for multi-hypothesis encoding and an apparatus.

### BACKGROUND

Video coding (video encoding and decoding) is widely used in digital video applications, for example, real-time session applications such as video transmission, video chat, and video conferencing over a broadcast digital television, the internet, and a mobile network, and safety applications of a DVD, a Blu-ray disc, a video content acquisition and editing system, and a portable camera.

With development of a block-based hybrid video encoding scheme in the H.261 standard in 1990, a new video encoding technology and tool have been developed to constitute a basis for a new video encoding standard. Other video encoding standards include MPEG-1 video, MPEG-2 video, ITU-T H.262/MPEG-2, ITU-T H.263, ITU-T H.264/MPEG-4 Part 10 advanced video coding (AVC), ITU-T H.265/high efficiency video coding (HEVC), and the like, and extensions of such standards, such as scalability and/or a 3D (three-dimensional) extension. As video creation and use become more widespread, video traffic becomes largest burden of a communication network and data storage. Therefore, one of objectives of most video encoding standards is to reduce a bit rate without sacrificing picture quality in comparison with a previous standard. Even though the latest high efficiency video coding (HEVC) can achieve a video compression amount approximately twice greater than AVC without sacrificing picture quality, a new technology is still urgently needed to further compress a video in comparison with HEVC.

### SUMMARY

Embodiments of the present disclosure provide a weighted prediction method for multi-hypothesis encoding and an apparatus, and a corresponding encoder and decoder, to improve prediction accuracy of a pixel value of a picture block and encoding/decoding performance to some extent.

According to a first aspect, an embodiment of this application provides a weighted prediction method for multi-hypothesis encoding, applicable to a decoder end. The method includes: determining a first target prediction block of a to-be-processed picture block based on an inter prediction mode; determining a second target prediction block of the to-be-processed picture block based on an intra prediction mode; determining, based on indication information in a bitstream, weight coefficients respectively corresponding to the inter prediction mode and the intra prediction mode; and weighting a pixel value of the first target prediction block and a pixel value of the second target prediction block based on the weight coefficients, to obtain a prediction value of the to-be-processed picture block. Therefore, in this embodiment of the present disclosure, the decoder end can parse the indication information in the bitstream to quickly determine the weight coefficients respectively corresponding to the inter prediction mode and the intra prediction mode, thereby ensuring normal execution of multi-hypothesis encoding in diversified scenarios, and improving picture prediction accuracy and encoding performance.

The indication information corresponds to different weight coefficient combinations in different cases, and the weight coefficient combination includes the weight coefficients respectively corresponding to the inter prediction mode and the intra prediction mode.

The multi-hypothesis encoding is using a plurality of prediction modes in prediction of a current block. In an embodiment, joint intra prediction encoding and inter prediction encoding may be implemented by using the multi-hypothesis encoding prediction mode; in other words, both the inter prediction mode and the intra prediction mode are used in the prediction of the current block. The inter prediction mode is a merge mode, and the intra prediction mode is a planar mode.

In an embodiment of the present disclosure, an encoder end may implicitly or explicitly indicate the weight coefficients respectively corresponding to the inter prediction mode and the intra prediction mode to the decoder end by using the indication information. A weight coefficient corresponding to the inter prediction mode is used to indicate a weight of the pixel value of the first target prediction block obtained by predicting the current block by using the inter prediction mode in weighted prediction for multi-hypothesis encoding, and a weight coefficient corresponding to the intra prediction mode is used to indicate a weight of the pixel value of the second target prediction block obtained by predicting the current block by using the intra prediction mode in the weighted prediction for multi-hypothesis encoding. In an embodiment of the present disclosure, the indication information corresponds to different weight coefficient combinations in different cases, and the weight coefficient combination includes the weight coefficients respectively corresponding to the inter prediction mode and the intra prediction mode.

It may be learned that, an embodiment of the present disclosure is implemented, so that the weight coefficients respectively corresponding to the inter prediction mode and the intra prediction mode can be adaptively determined based on different encoding/decoding scenarios, thereby ensuring normal execution of multi-hypothesis encoding in diversified scenarios, and improving picture prediction accuracy and encoding performance.

Based on the first aspect, in an embodiment, the indication information includes reference picture queue information, and the reference picture queue information is used to indicate a reference picture queue corresponding to the to-be-processed picture block.

The determining, based on indication information in a bitstream, weight coefficients respectively corresponding to the inter prediction mode and the intra prediction mode includes: determining, based on the reference picture queue information, encoding configuration information corresponding to the to-be-processed picture block; and determining, based on the encoding configuration information corresponding to the to-be-processed picture block, the weight coefficients respectively corresponding to the inter prediction mode and the intra prediction mode.

It may be learned that, the indication information may implicitly indicate the encoding configuration information corresponding to current encoding/decoding, and a corresponding weight coefficient combination can be adaptively and quickly determined based on a mapping relationship between encoding configuration information and a weight coefficient combination {Mi, Ni}, thereby improving picture prediction accuracy and encoding performance.

In an embodiment, the mapping relationship between encoding configuration information and a weight coefficient combination {Mi, Ni} may be established in advance. When the encoding configuration information corresponding to the to-be-processed picture block represents one of a low delay configuration, a P slice only configuration, or a B slice only configuration, the weight coefficients corresponding to the inter prediction mode and the intra prediction mode are determined as M1 and N1 respectively, where M1 is not equal to N1. In a possible embodiment, M1 is greater than N1.

For example, the indication information is slice-level or frame-level reference picture queue construction information transmitted by the encoder end to the decoder end by using the bitstream. The decoder end constructs the reference picture queue based on the information. The reference picture queue includes one or more reference picture lists, for example, list0, list1, list2, If finding, based on picture order counts (POC), that reference pictures in all the reference picture lists in the reference picture queue are all located before the current to-be-decoded picture in time domain, the decoder end determines that a current encoding configuration is the low delay configuration.

When the encoding configuration information corresponding to the to-be-processed picture block is a random access configuration, it may be set that equal-ratio weighting is used for the intra prediction block and the inter prediction block.

Based on the first aspect, in an embodiment, the indication information includes reference picture queue information, the reference picture queue information is used to indicate a reference picture queue corresponding to the to-be-processed picture block, the reference picture queue includes at least one reference picture set, and each of the at least one reference picture set includes one or more reference pictures.

A time-domain distance between each reference picture in any reference picture set and the to-be-processed picture block may be determined, and a minimum time-domain distance value may be determined as a closest time-domain distance of the any reference picture set; and the weight coefficients respectively corresponding to the inter prediction mode and the intra prediction mode may be set based on the closest time-domain distance.

A process of determining a closest time-domain distance corresponding to any reference picture set may be: for all reference picture sets in the reference picture queue, traversing each reference picture set to obtain a closest time-domain distance corresponding to each reference picture set; or may be: for several reference picture sets in the reference picture queue, traversing each reference picture set to obtain a closest time-domain distance corresponding to each reference picture set.

For example, the reference picture queue may include one or more reference picture lists, for example, may be list0, list1, . . . , and listN, where N is an integer greater than or equal to 0. Each reference picture list includes one or more frames of reference pictures, a time-domain distance between a reference picture in the reference picture list and a current picture may be denoted as pocDiff, and pocDiff may be obtained through calculation based on an absolute value of a difference between a POC of the reference picture and a POC of the current picture. A time-domain distance between a reference picture closest to the current picture in the reference picture list and the current picture is referred to as a closest time-domain distance and is denoted as pocDiffmin; in other words, pocDiffmin is a minimum value in pocDiff corresponding to all the reference pictures in the reference picture list. For the reference picture queue, pocDiffmin corresponding to different reference picture lists may be respectively denoted as pocDiffmin0, pocDiffmin1, . . . , and pocDiffminN. In this case, the weight coefficient combination may be determined based on pocDiffmin corresponding to different reference picture lists.

In an embodiment, a minimum value in pocDiffmin0, pocDiffmin1, . . . , and pocDiffminN is denoted as Lmin. In this case, a mapping relationship between Lmin and a weight coefficient combination {Mi, Ni} may be established in advance, and the weight coefficients respectively corresponding to the inter prediction mode and the intra prediction mode may be determined based on Lmin.

In a possible embodiment, when Lmin is less than or equal to a first preset value, the weight coefficients respectively corresponding to the inter prediction mode and the intra prediction mode are determined as M1 and N1 respectively; or when Lmin is greater than the first preset value and less than or equal to a second preset value, the weight coefficients respectively corresponding to the inter prediction mode and the intra prediction mode are determined as M2 and N2 respectively.

The first preset value is less than the second preset value, a ratio of M1 to N1 is less than a ratio of M2 to N2, and M1, M2, N1, and N2 are positive integers.

In an embodiment, a maximum value in pocDiffmin0, pocDiffmin1, . . . , and pocDiffminN is denoted as Lmax. In this case, a mapping relationship between Lmax and a weight coefficient combination {Mi, Ni} may be established in advance, and the weight coefficients respectively corresponding to the inter prediction mode and the intra prediction mode may be determined based on Lmax.

In a possible embodiment, when Lmax is less than or equal to a first preset value, the weight coefficients respectively corresponding to the inter prediction mode and the intra prediction mode are determined as M1 and N1 respectively; or when Lmax is greater than the first preset value and less than or equal to a second preset value, the weight coefficients respectively corresponding to the inter prediction mode and the intra prediction mode are determined as M2 and N2 respectively.

The first preset value is less than the second preset value, a ratio of M1 to N1 is less than a ratio of M2 to N2, and M1, M2, N1, and N2 are positive integers.

In an embodiment, an average value of pocDiffmin0, pocDiffmin1, . . . , and pocDiffminN is denoted as Lavg. In this case, a mapping relationship between Lavg and a weight coefficient combination {Mi, Ni} may be established, and the weight coefficients respectively corresponding to the inter prediction mode and the intra prediction mode may be determined based on Lavg.

It may be learned that, in the foregoing solution, the decoder end may parse the bitstream to obtain indication information of a closest time-domain distance of the reference picture queue. The indication information is slice-level or frame-level reference picture queue construction information transmitted by the encoder end to the decoder end by using the bitstream. The decoder end constructs the reference picture queue based on the information, and obtains pocDiffmin0, pocDiffmin1, . . . , and pocDiffminN based on a POC of each reference picture in each reference picture list and the POC of the current picture, and then can adaptively and quickly obtain, based on the mapping relationship between a minimum value Lmin, a maximum value Lmax, or an average value Lavg and a weight coefficient combination {Mi, Ni}, the weight coefficients respectively corresponding to the inter prediction mode and the intra prediction mode, thereby improving picture prediction accuracy and encoding performance.

In an embodiment, the indication information includes preset reference picture set information, and the preset reference picture set information is used to indicate a preset reference picture set (for example, a preset reference picture list) in a reference picture queue.

An average value of pocDiff of all reference pictures in the preset reference picture list (for example, list0) in the reference picture queue may be denoted as Ravg. In this case, a mapping relationship between Ravg and a weight coefficient combination {Mi, Ni} may be established in advance, and the weight coefficients respectively corresponding to the inter prediction mode and the intra prediction mode may be determined based on Ravg.

In a possible embodiment, when Ravg is less than or equal to a first preset value, the weight coefficients respectively corresponding to the inter prediction mode and the intra prediction mode are determined as M1 and N1 respectively; or when Ravg is greater than the first preset value and less than or equal to a second preset value, the weight coefficients respectively corresponding to the inter prediction mode and the intra prediction mode are determined as M2 and N2 respectively.

The first preset value is less than the second preset value, a ratio of M1 to N1 is less than a ratio of M2 to N2, and M1, M2, N1, and N2 are positive integers.

It may be learned that, in the foregoing solution, the decoder end may parse the bitstream to obtain indication information of a closest time-domain distance of the reference picture queue. For example, the indication information is slice-level or frame-level reference picture queue construction information transmitted by the encoder end to the decoder end by using the bitstream. The decoder end constructs the reference picture queue based on the information, and determines the preset reference picture list (for example, list0) from the reference picture queue, and therefore can obtain Ravg based on a POC of each reference picture in the preset reference picture list (for example, list0) and a POC of a current picture, and then can adaptively and quickly obtain, based on the mapping relationship between Ravg and a weight coefficient combination {Mi, Ni}, the weight coefficients respectively corresponding to the inter prediction mode and the intra prediction mode, thereby improving picture prediction accuracy and encoding performance.

Based on the first aspect, in an embodiment, the indication information in the bitstream includes reference picture queue information, the reference picture queue information is used to indicate a reference picture queue corresponding to the to-be-processed picture block, the reference picture queue includes at least one reference picture set, and each of the at least one reference picture set includes at least one reference picture.

A picture order count (POC) of each reference picture in any reference picture set may be determined; and the weight coefficients respectively corresponding to the inter prediction mode and the intra prediction mode are determined based on POCs of reference pictures respectively corresponding to all reference picture sets. In other words, the weight coefficients respectively corresponding to the inter prediction mode and the intra prediction mode may be set based on features such as quantities of reference pictures in different reference picture lists in the reference picture queue.

A process of determining a POC of a reference picture corresponding to any reference picture set may be: for all the reference picture sets in the reference picture queue, traversing each reference picture set to obtain a POC of each reference picture in each reference picture set; or may be: for several reference picture sets in the reference picture queue, traversing each reference picture set to obtain a POC of each reference picture in each reference picture set.

In a possible embodiment, when the plurality of reference picture sets each include only one reference picture, all reference pictures have a same POC, and the reference pictures with the same POC are located before the to-be-processed picture block in time domain (which may be referred to as a preset condition 1), the weight coefficients respectively corresponding to the inter prediction mode and the intra prediction mode are determined as M1 and N1 respectively; or in a case other than the case (which may be referred to as a preset condition 2), the weight coefficients respectively corresponding to the inter prediction mode and the intra prediction mode are determined as M2 and N2 respectively. A ratio of M1 to N1 is less than a ratio of M2 to N2, and M1, M2, N1, and N2 are positive integers.

In a possible embodiment, when the plurality of reference picture sets include reference pictures with different POCs and all the reference pictures in all the reference picture sets are located before the to-be-processed picture block in time domain (which may be referred to as a preset condition 3), the weight coefficients respectively corresponding to the inter prediction mode and the intra prediction mode are determined as M2 and N2 respectively; or in a case other than the case (which may be referred to as a preset condition 4), the weight coefficients respectively corresponding to the inter prediction mode and the intra prediction mode are determined as M1 and N1 respectively. A ratio of M1 to N1 is less than a ratio of M2 to N2, and M1, M2, N1, and N2 are positive integers.

In the foregoing solution, the decoder end may parse the bitstream to obtain indication information of a closest time-domain distance of the reference picture queue. For example, the indication information is slice-level or frame-level reference picture queue construction information transmitted by the encoder end to the decoder end by using the bitstream. The decoder end constructs the reference picture queue based on the information. The decoder end may determine, based on quantities of reference pictures in different reference picture lists, a preset condition met by a current encoding/decoding status, and can adaptively and quickly obtain, based on a mapping relationship between a preset condition and a weight coefficient combination {Mi, Ni}, the weight coefficients respectively corresponding to the inter prediction mode and the intra prediction mode, thereby improving picture prediction accuracy and encoding performance.

In an embodiment described above, the encoder end mainly implicitly indicates the weight coefficients respectively corresponding to the inter prediction mode and the intra prediction mode to the decoder end. In an embodiment, the encoder end may directly explicitly indicate the weight coefficients respectively corresponding to the inter prediction mode and the intra prediction mode to the decoder end.

Based on the first aspect, in an embodiment, the indication information in the bitstream includes a weight indicator bit of slice header information in the bitstream, and the weight indicator bit of the slice header information may be directly used to indicate the weight coefficient combination; in other words, there are mapping relationships between different values of the weight indicator bit and weight coefficient combinations {Mi, Ni}. The weight coefficients respectively corresponding to the inter prediction mode and the intra prediction mode may be determined based on the weight indicator bit of the slice header information.

In a possible embodiment, when the weight indicator bit of the slice header information is a first indication value, the weight coefficients respectively corresponding to the inter prediction mode and the intra prediction mode are determined as M1 and N1 respectively; or when the weight indicator bit of the slice header information is a second indication value, the weight coefficients respectively corresponding to the inter prediction mode and the intra prediction mode are determined as M2 and N2 respectively. A ratio of M1 to N1 is less than a ratio of M2 to N2, and M1, M2, N1, and N2 are positive integers.

In a possible embodiment, the determining, based on the weight indicator bit of the slice header information, the weight coefficients respectively corresponding to the inter prediction mode and the intra prediction mode includes: when the weight indicator bit of the slice header information is a first indication value, respectively determining the weight coefficient corresponding to the inter prediction mode and the weight coefficient corresponding to the intra prediction mode from a first set and a second set based on the first indication value; or when the weight indicator bit of the slice header information is a second indication value, respectively determining the weight coefficient corresponding to the inter prediction mode and the weight coefficient corresponding to the intra prediction mode from a first set and a second set based on the second indication value. A ratio of the weight coefficient that is of the inter prediction mode and that is determined based on the first indication value to the weight coefficient that is of the intra prediction mode and that is determined based on the first indication value is less than a ratio of the weight coefficient that is of the inter prediction mode and that is determined based on the second indication value to the weight coefficient that is of the intra prediction mode and that is determined based on the second indication value.

In a possible embodiment, when the plurality of reference picture sets include reference pictures with different POCs and all reference pictures in all the reference picture sets are located before the to-be-processed picture block in time domain, the first set includes M1 and M2, and the second set includes N1 and N2; or in a case other than the case, the first set includes M3 and M4, and the second set includes N3 and N4. A ratio of M1 to N1 is less than a ratio of M3 to N3, a ratio of M2 to N2 is less than a ratio of M4 to N4, and M1, M2, M3, M4, N1, N2, N3, and N4 are positive integers.

In the foregoing solution, the decoder end may parse the bitstream to obtain the weight indicator bit of the slice header information, and can adaptively and quickly obtain, based on the mapping relationships between different values of the weight indicator bit of the slice header information and weight coefficient combinations {Mi, Ni}, the weight coefficients respectively corresponding to the inter prediction mode and the intra prediction mode, thereby improving picture prediction accuracy and encoding performance.

Based on the first aspect, in an embodiment, the indication information transmitted by the encoder end to the decoder end by using the bitstream includes a weight indicator bit of largest coding unit (LCU) information in a syntax element, and the weight indicator bit of the LCU information may also be used to determine the weight coefficient combination. The decoder end may determine, based on the weight indicator bit of the LCU information, the weight coefficients respectively corresponding to the inter prediction mode and the intra prediction mode.

In a possible embodiment, when the weight indicator bit of the LCU information is a third indication value, the weight coefficients respectively corresponding to the inter prediction mode and the intra prediction mode are set to M1 and N1 respectively; or when the weight indicator bit of the LCU information is a fourth indication value, the weight coefficients respectively corresponding to the inter prediction mode and the intra prediction mode are set to M2 and N2 respectively. A ratio of M1 to N1 is less than a ratio of M2 to N2, and M1, M2, N1, and N2 are positive integers.

In a possible embodiment, when the weight indicator bit of the LCU information is a third indication value, the weight coefficient corresponding to the inter prediction mode and the weight coefficient corresponding to the intra prediction mode are respectively determined from a third set and a fourth set based on the third indication value; or when the weight indicator bit of the LCU information is a fourth indication value, the weight coefficient corresponding to the inter prediction mode and the weight coefficient corresponding to the intra prediction mode are respectively determined from a third set and a fourth set based on the fourth indication value. A ratio of the weight coefficient that is of the inter prediction mode and that is determined based on the third indication value to the weight coefficient that is of the intra prediction mode and that is determined based on the third indication value is less than a ratio of the weight coefficient that is of the inter prediction mode and that is determined based on the fourth indication value to the weight coefficient that is of the intra prediction mode and that is determined based on the fourth indication value.

In a possible embodiment, when the plurality of reference picture sets include reference pictures with different POCs and all reference pictures in all the reference picture sets are located before the to-be-processed picture block in time domain, the third set includes M1 and M2, and the fourth set includes N1 and N2; or in a case other than the case, the third set includes M3 and M4, and the fourth set includes N3 and N4. A ratio of M1 to N1 is less than a ratio of M3 to N3, a ratio of M2 to N2 is less than a ratio of M4 to N4, and M1, M2, M3, M4, N1, N2, N3, and N4 are positive integers.

In the foregoing solution, the decoder end may parse the bitstream to obtain the weight indicator bit of the LCU information, and can adaptively and quickly obtain, based on relationships between different values of the weight indicator bit of the LCU information and weight coefficient combinations {Mi, Ni}, the weight coefficients respectively corresponding to the inter prediction mode and the intra prediction mode, thereby improving picture prediction accuracy and encoding performance.

Based on the first aspect, in an embodiment, the indication information in the bitstream includes both a weight indicator bit of slice header information and a weight indicator bit of LCU information in the bitstream.

When the weight indicator bit of the slice header information is a first indication value, the third set includes M1 and M2, and the fourth set includes N1 and N2; or when the weight indicator bit of the slice header information is a second indication value, the third set includes M3 and M4, and the fourth set includes N3 and N4. A ratio of M1 to N1 is less than a ratio of M3 to N3, a ratio of M2 to N2 is less than a ratio of M4 to N4, and M1, M2, M3, M4, N1, N2, N3, and N4 are positive integers.

In the foregoing solution, the decoder end may parse the bitstream to obtain the weight indicator bit of the LCU information and the weight indicator bit of the slice header information, and can also adaptively and quickly obtain, based on the weight indicator bit of the LCU information and the weight indicator bit of the slice header information, the weight coefficients respectively corresponding to the inter prediction mode and the intra prediction mode, thereby improving picture prediction accuracy and encoding performance.

Based on the first aspect, in an embodiment, the indication information transmitted by the encoder end to the decoder end by using the bitstream includes a weight indicator bit of coding unit (CU) information in a syntax element, and the weight indicator bit of the CU information may also be used to determine the weight coefficient combination. The decoder end may determine, based on the weight indicator bit of the CU information, the weight coefficients respectively corresponding to the inter prediction mode and the intra prediction mode.

In a possible embodiment, a weight coefficient set corresponding to the inter prediction mode and a weight coefficient set corresponding to the intra prediction mode are respectively determined as a fifth set and a sixth set based on the weight indicator bit of the slice header information.

When the weight indicator bit of the CU information is a fifth indication value, the weight coefficient corresponding to the inter prediction mode and the weight coefficient corresponding to the intra prediction mode are respectively determined from the fifth set and the sixth set based on the fifth indication value; or when the weight indicator bit of the CU information is a sixth indication value, the weight coefficient corresponding to the inter prediction mode and the weight coefficient corresponding to the intra prediction mode are respectively determined from the fifth set and the sixth set based on the sixth indication value. A ratio of the weight coefficient that is of the inter prediction mode and that is determined based on the fifth indication value to the weight coefficient that is of the intra prediction mode and that is determined based on the fifth indication value is less than a ratio of the weight coefficient that is of the inter prediction mode and that is determined based on the sixth indication value to the weight coefficient that is of the intra prediction mode and that is determined based on the sixth indication value.

In the foregoing solution, the decoder end may parse the bitstream to obtain the weight indicator bit of the CU information, and adaptively and quickly obtain, based on relationships between different values of the weight indicator bit of the CU information and weight coefficient combinations {Mi, Ni}, the weight coefficients respectively corresponding to the inter prediction mode and the intra prediction mode, thereby improving picture prediction accuracy and encoding performance.

Based on the first aspect, in an embodiment, the indication information in the bitstream includes both a weight indicator bit of slice header information and a weight indicator bit of CU information in the bitstream. When the weight indicator bit of the slice header information is a first indication value, the fifth set includes M1 and M2, and the sixth set includes N1 and N2; or when the weight indicator bit of the slice header information is a second indication value, the fifth set includes M3 and M4, and the sixth set includes N3 and N4. A ratio of M1 to N1 is less than a ratio of M3 to N3, a ratio of M2 to N2 is less than a ratio of M4 to N4, and M1, M2, M3, M4, N1, N2, N3, and N4 are positive integers.

In the foregoing solution, the decoder end may parse the bitstream to obtain the weight indicator bit of the CU information and the weight indicator bit of the slice header information, and can also adaptively and quickly obtain, based on the weight indicator bit of the CU information and the weight indicator bit of the slice header information, the weight coefficients respectively corresponding to the inter prediction mode and the intra prediction mode, thereby improving picture prediction accuracy and encoding performance.

Based on the first aspect, in an embodiment, the indication information includes encoding configuration information corresponding to the to-be-processed picture block, and the encoding configuration information corresponding to the to-be-processed picture block may be, for example, one of a low delay configuration, a P slice only (P slice only) configuration, a B slice only configuration, or a random access configuration.

When the encoding configuration information is one of the low delay configuration, the P slice only configuration, or the B slice only configuration, the weight coefficients corresponding to the inter prediction mode and the intra prediction mode are determined as M1 and N1 respectively, where M1 is not equal to N1. In a possible embodiment, M1 is greater than N1.

When the encoding configuration information corresponding to the to-be-processed picture block is the random access configuration, it may be set that equal-ratio weighting is used for the intra prediction block and the inter prediction block.

Correspondingly, the determining, based on indication information in a bitstream, weight coefficients respectively corresponding to the inter prediction mode and the intra prediction mode includes: determining, based on the encoding configuration information corresponding to the to-be-processed picture block, the weight coefficients respectively corresponding to the inter prediction mode and the intra prediction mode.

It may be learned that, when the bitstream can carry the encoding configuration information corresponding to current encoding/decoding, a corresponding weight coefficient combination can be adaptively and quickly determined based on a mapping relationship between encoding configuration information and a weight coefficient combination {Mi, Ni}, thereby improving picture prediction accuracy and encoding performance.

Based on the first aspect, in an embodiment, after determining the weight coefficient combination {Mi, Ni} corresponding to the weighted prediction of the current block, the decoder end may weight the pixel value of the first target prediction block and the pixel value of the second target prediction block by using the weight coefficient combination {Mi, Ni}, to obtain the prediction value of the current block.

For example, a prediction pixel value of a location point in the current block is denoted as Samples[x][y], x and y are a horizontal coordinate and a vertical coordinate of the pixel value respectively, and Samples[x][y] may be obtained through calculation by using the following formula:

Samples [x][y]=Clip3 (0, ((1<<bitDepth)−1), ((predSamplesIntra[x][y]*Ni+predSamplesInter[x][y]*Mi+offset)>>shift))

Clip3(.) is a clip function, bitDepth is a bit depth of Samples data, predSamplesIntra[x][y] represents an intra prediction pixel value of a [x][y] location, predSamplesInter[x][y] represents an inter prediction pixel value of the [x][y] location, and offset represents value precision.

In an embodiment, a value of shift may be determined in a manner in which a sum of Mi and Ni is equal to 2 raised to the power of shift, to omit an unnecessary division operation.

Based on the first aspect, in an embodiment, the bitstream may be parsed to obtain a flag of the multi-hypothesis encoding with joint intra prediction encoding and inter prediction encoding and a syntax element related to the prediction mode.

In an embodiment, the flag of the multi-hypothesis encoding may be mh_intra_flag. When mh_intra_flag indicates that the multi-hypothesis encoding mode with joint intra prediction encoding and inter prediction encoding is used for current decoding, a syntax element related to the intra encoding mode is parsed out from the bitstream.

In an instance, the syntax element of the intra encoding mode may include a most probable mode flag mh_intra_luma_mpm_flag and a most probable mode index mh_intra_luma_mpm_idx, mh_intra_luma_mpm_flag is used to indicate to perform the intra encoding mode, and mh_intra_luma_mpm_idx represents an index number of an intra candidate list (intra candidate list). The intra prediction mode may be selected from the intra candidate list based on the index number.

In another instance, for intra prediction encoding, no index may be transmitted in the bitstream. In this case, a preset mode (for example, the planar mode) may be directly used as the intra encoding mode of the current block.

When the multi-hypothesis encoding mode with joint intra prediction encoding and inter prediction encoding is used for the current decoding, the inter prediction mode is determined based on an inter prediction encoding flag. For example, the inter prediction encoding flag may be “merge_flag” used to indicate to perform the merge mode. For another example, in a possible embodiment, the inter prediction encoding flag may be used to indicate to perform an inter MVP mode (for example, an AMVP mode).

According to a second aspect, an embodiment of the present disclosure provides an apparatus. The apparatus includes: a first prediction module, configured to determine a first target prediction block of a to-be-processed picture block based on an inter prediction mode; a second prediction module, configured to determine a second target prediction block of the to-be-processed picture block based on an intra prediction mode; a weight coefficient determining module, configured to determine, based on indication information in a bitstream, weight coefficients respectively corresponding to the inter prediction mode and the intra prediction mode; and a third prediction module, configured to weight a pixel value of the first target prediction block and a pixel value of the second target prediction block based on the weight coefficients, to obtain a prediction value of the to-be-processed picture block.

The functional modules in the apparatus may be configured to implement the method described in the first aspect.

According to a third aspect, an embodiment of the present disclosure provides a video encoding/decoding device. The device includes a nonvolatile memory and a processor coupled to each other. The processor invokes program code stored in the memory, to: determine a first target prediction block of a to-be-processed picture block based on an inter prediction mode; determine a second target prediction block of the to-be-processed picture block based on an intra prediction mode; determine, based on indication information in a bitstream, weight coefficients respectively corresponding to the inter prediction mode and the intra prediction mode, where the indication information corresponds to different weight coefficient combinations in different cases, and the weight coefficient combination includes the weight coefficients respectively corresponding to the inter prediction mode and the intra prediction mode; and weight a pixel value of the first target prediction block and a pixel value of the second target prediction block based on the weight coefficients, to obtain a prediction value of the to-be-processed picture block.

For example, the processor invokes the program code stored in the memory, to perform the method according to any one of the first aspect or the embodiments of the first aspect.

According to a fourth aspect, an embodiment of the present disclosure provides a video decoding device. The device includes:

a memory, configured to store video data in a bitstream form; and

a decoder, configured to: determine a first target prediction block of a to-be-processed picture block based on an inter prediction mode; determine a second target prediction block of the to-be-processed picture block based on an intra prediction mode; determine, based on indication information in a bitstream, weight coefficients respectively corresponding to the inter prediction mode and the intra prediction mode, where the indication information corresponds to different weight coefficient combinations in different cases, and the weight coefficient combination includes the weight coefficients respectively corresponding to the inter prediction mode and the intra prediction mode; and weight a pixel value of the first target prediction block and a pixel value of the second target prediction block based on the weight coefficients, to obtain a prediction value of the to-be-processed picture block.

For example, the decoder may be configured to perform the method according to any one of the first aspect or the embodiments of the first aspect.

According to a fifth aspect, an embodiment of the present disclosure provides a computer readable storage medium. The computer readable storage medium stores an instruction. When the instruction is executed, one or more processors are enabled to encode video data. The instruction enables the one or more processors to perform the method according to any one of the first aspect or the possible embodiments of the first aspect.

According to a sixth aspect, an embodiment of the present disclosure provides a computer program including program code. When the program code is run on a computer, the method according to any one of the first aspect or the possible embodiments of the first aspect is performed.

It may be learned that, in a multi-hypothesis encoding prediction process with joint intra prediction encoding and inter prediction encoding in an embodiments of the present disclosure, the decoder end may parse out the information from the bitstream to adaptively determine, based on different encoding/decoding scenarios, the weight coefficients respectively corresponding to the inter prediction mode and the intra prediction mode, thereby ensuring normal execution of multi-hypothesis encoding in diversified scenarios, and improving picture prediction accuracy and encoding efficiency and performance.

### BRIEF DESCRIPTION OF DRAWINGS

To describe the technical solutions in the embodiments of the present disclosure or in the background more clearly, the following briefly describes the accompanying drawings required for describing the embodiments of the present disclosure or the background.

FIG. 1A is a block diagram of an instance of a video encoding and decoding system 10 for implementing an embodiment of the present disclosure;

FIG. 1B is a block diagram of an instance of a video coding system 40 for implementing an embodiment of the present disclosure;

FIG. 2 is a structural block diagram of an instance of an encoder 20 for implementing an embodiment of the present disclosure;

FIG. 3 is a structural block diagram of an instance of a decoder 30 for implementing an embodiment of the present disclosure;

FIG. 4 is a block diagram of an instance of a video coding device 400 for implementing an embodiment of the present disclosure;

FIG. 5 is a block diagram of an instance of another encoding apparatus or decoding apparatus for implementing an embodiment of the present disclosure;

FIG. 6 is an example schematic diagram of a planar (inter planar mode) technology;

FIG. 7 is a schematic diagram of a mapping relationship between encoding configuration information and a weight coefficient combination;

FIG. 8 is a schematic diagram of a mapping relationship between Lmin and a weight coefficient combination;

FIG. 9 is a schematic diagram of a mapping relationship between Lmax and a weight coefficient combination;

FIG. 10 is a schematic diagram of a mapping relationship between Lavg and a weight coefficient combination;

FIG. 11 is a schematic diagram of a mapping relationship between Ravg and a weight coefficient combination;

FIG. 12 is a schematic diagram of mapping relationships between some preset conditions and weight coefficient combinations;

FIG. 13 is a schematic diagram of a mapping relationship between a preset condition and a weight coefficient combination;

FIG. 14 is a schematic diagram of mapping relationships between some weight indicator bits of slice header information and weight coefficient combinations;

FIG. 15 is a schematic diagram of mapping relationships between some other weight indicator bits of slice header information and weight coefficient combinations;

FIG. 16 is an example flowchart of a weighted prediction method for multi-hypothesis encoding;

FIG. 17 is another example flowchart of a weighted prediction method for multi-hypothesis encoding; and

FIG. 18 is a block diagram of an instance of an apparatus 1000 for implementing an embodiment of the present disclosure.

### DESCRIPTION OF EMBODIMENTS

The following describes the embodiments of the present disclosure with reference to the accompanying drawings in the embodiments of the present disclosure. In the following description, reference is made to the accompanying drawings that constitute a part of this disclosure and that illustrate aspects of the embodiments of the present disclosure or that can be used in aspects of the embodiments of the present disclosure. It should be understood that the embodiments of the present disclosure may be used in other aspects, and may include structural or logical changes not depicted in the accompanying drawings. Therefore, the following detailed description should not be construed in a limitative sense, and the scope of the present disclosure is defined by the appended claims. For example, it should be understood that content disclosed with reference to the described method is also applicable to a corresponding device or system for performing the method, and vice versa. For example, if one or more method operations are described, a corresponding device may include one or more units such as functional units, to perform the described one or more method operations (for example, one unit performs the one or more operations, or each of a plurality of units performs one or more of a plurality of operations), even though such one or more units are not clearly described or illustrated in the accompanying drawings. In addition, for example, if an apparatus is described based on one or more units such as functional units, a corresponding method may include one or more operations to implement functionality of the one or more units (for example, one operation implements the functionality of the one or more units, or each of a plurality of operations implements functionality of one or more of a plurality of units), even though such one or more operations are not clearly described or illustrated in the accompanying drawings. Further, it should be understood that, unless otherwise clearly proposed, features of the example embodiments and/or aspects described in this specification may be combined with each other.

In the embodiments of the present disclosure, “at least one” means one or more, and “a plurality of” means two or more. “and/or” describes an association relationship between associated objects, and represents that there may be three relationships. For example, A and/or B may represent a case in which only A exists, both A and B exist, or only B exists, where A and B may be singular or plural. The character “/” generally indicates an “or” relationship between the associated objects. “at least one of the following items (pieces)” or a similar expression thereof means any combination of these items, including a singular term (piece) or any combination of plural terms (pieces). For example, at least one of a, b, or c may represent a, b, c, a-b, a-c, b-c, or a-b-c, where a, b, and c may be singular or plural.

Technical solutions in the embodiments of the present disclosure may be applied to not only an existing video encoding standard (such as H.264 or HEVC) but also a future video encoding standard (such as the H.266 standard). Terms used in the embodiments of the present disclosure are intended only to explain embodiments of the present disclosure, and not intended to limit the present disclosure. The following first simply describes some concepts that may be involved in the embodiments of the present disclosure.

Video encoding usually means processing a picture sequence constituting a video or video sequence. In the video encoding field, terms “picture”, “frame”, or “image ” may be used as a synonym, and terms “pixel value”, “sampling value”, or “sampling signal” may be used as a synonym. Video encoding used in this specification represents video encoding or decoding. The video encoding is performed on a source side, and usually includes processing (for example, compressing) an original video picture to reduce a data amount required to represent the video picture, for more efficient storage and/or transmission. The video decoding is performed on a destination side, and usually includes performing inverse processing with respect to an encoder to reconstruct a video picture. “Encoding” of a video picture in the embodiments should be understood as “encoding” or “decoding” related to a video sequence. A combination of encoding and decoding is also referred to as encoding/decoding.

The video sequence includes a series of pictures, the picture is further divided into slices (slice), and the slice is further divided into blocks. Video encoding may be performed in one block. In some new video encoding standards, the concept of block is further extended. For example, there is a macroblock (MB) in the H.264 standard, and the macroblock may be further divided into a plurality of prediction blocks (partition) available for prediction encoding. In the high efficiency video coding (HEVC) standard, a plurality of types of block units are functionally obtained through division by using basic concepts such as a coding unit (CU), a prediction unit (PU), and a transform unit (TU), and are described by using anew tree-based structure. For example, the CU may be divided into smaller CUs based on a quad-tree, and the smaller CU may be further divided to constitute a quad-tree structure. The CU is a basic unit for dividing and encoding an encoded picture. There is a similar tree structure for each of the PU and the TU. The PU may correspond to a prediction block and is a basic unit of prediction encoding. The CU is further divided into a plurality of PUs based on a division mode. The TU may correspond to a transform block and is a basic unit for transforming a predicted residual. However, the CU, the PU, and the TU all essentially belong to the concept of block (or referred to as picture block).

For example, in HEVC, a CTU is divided into a plurality of CUs by using a quad-tree structure represented as an encoding tree. It is determined, at a CU level, whether to encode a picture area by using inter picture (temporal) or intra picture (spatial) prediction. Each CU may be further divided into one, two, or four PUs based on a PU division type. A same prediction process is applied within one PU and related information is transmitted to a decoder on a PU basis. After a residual block is obtained by applying a prediction process based on the PU division type, the CU may be partitioned into transform units (TU) based on another quad-tree structure similar to the encoding tree used for the CU. In latest development of a video compression technology, a quad-tree and binary tree (QTBT) is used to partition an encoding block. In a QTBT block structure, the CU may be square or rectangular.

In this specification, for ease of description and understanding, a to-be-processed picture block in a currently encoded picture may be referred to as a to-be-processed picture block, which is referred to as a current block. For example, at an encoder end, a to-be-processed picture block is a currently encoded block; and at a decoder end, a to-be-processed picture block is a currently decoded block. A decoded picture block used to predict a current block in a reference picture is referred to as a prediction block (or referred to as a reference block or a motion compensation block); in other words, the prediction block (or referred to as the reference block or the motion compensation block) is a block that provides a reference signal for the current block. The reference signal represents a pixel value, a sampling value, or a sampling signal in the prediction block.

In a case of lossless video encoding, an original video picture may be reconstructed; in other words, a reconstructed video picture has same quality as the original video picture (assuming that there is no transmission loss or another data loss during storage or transmission). In a case of lossy video encoding, for example, quantization is performed for further compression to reduce a data amount required to represent a video picture, but a decoder side cannot completely reconstruct the video picture; in other words quality of a reconstructed video picture is lower or worse than quality of the original video picture.

Several video encoding standards of H.261 belong to “lossy hybrid video encoding/decoding” (that is, spatial and temporal prediction in sample domain are combined with 2D transform encoding for applying quantization in transform domain). Each picture in a video sequence is usually partitioned into non-overlapping block sets, and is usually encoded at a block level. In other words, an encoder side usually processes, namely, encodes a video at the block (video block) level, for example, generates prediction blocks by using spatial (intra picture) prediction and temporal (inter picture) prediction, subtracts a motion compensation block from a current block to obtain a residual block, and transforms the residual block in transform domain and quantizes the residual block to reduce an amount of to-be-transmitted (compressed) data; and a decoder side applies an inverse processing part with respect to an encoder to an encoded or compressed block, to reconstruct the current block. In addition, the encoder replicates a processing loop of a decoder, so that the encoder generates same prediction (for example, intra prediction and inter prediction) and/or reconstruction as the decoder, for processing, namely, encoding a subsequent block.

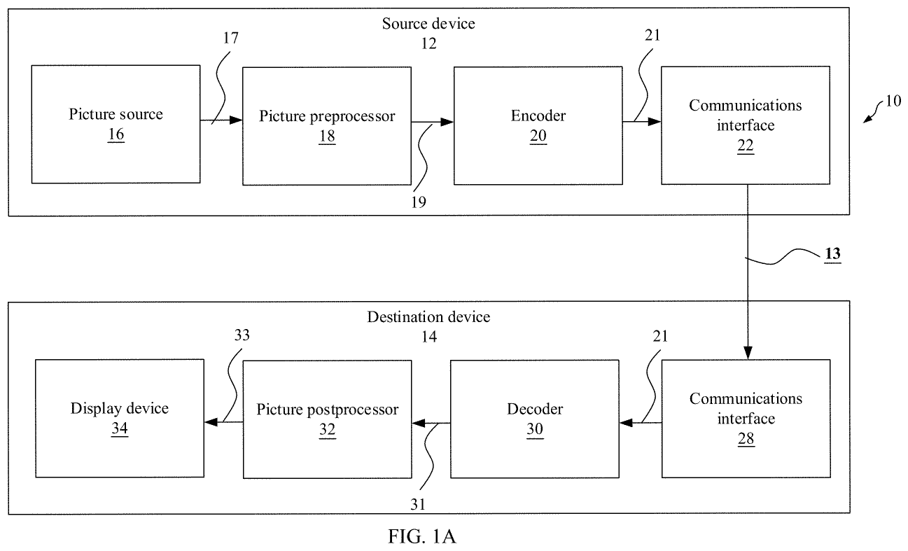

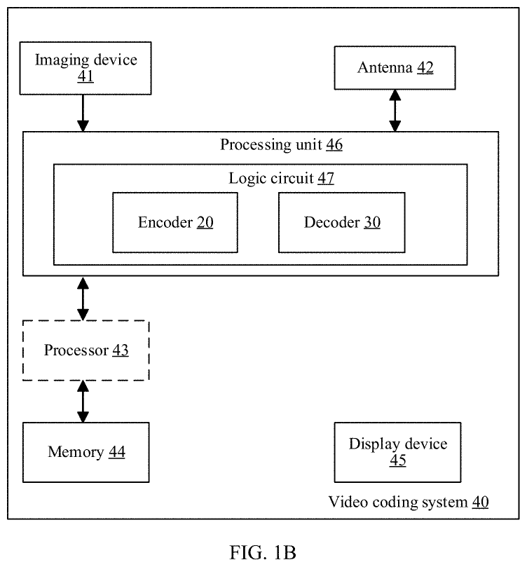

The following describes a system architecture to which the embodiments of the present disclosure are applied. FIG. 1A is an example schematic block diagram of a video encoding and decoding system 10 to which an embodiment of the present disclosure is applied. As shown in FIG. 1A, the video encoding and decoding system 10 may include a source device 12 and a destination device 14. The source device 12 generates encoded video data. Therefore, the source device 12 may be referred to as a video encoding apparatus. The destination device 14 may decode the encoded video data generated by the source device 12. Therefore, the destination device 14 may be referred to as a video decoding apparatus. Various embodiments of the source device 12, the destination device 14, or both may include one or more processors and a memory coupled to the one or more processors. The memory may include but is not limited to a RAM, a ROM, an EEPROM, a flash memory, or any other media that can be configured to store desired program code in a form of an instruction or a data structure accessible to a computer, as described in this specification. The source device 12 and the destination device 14 may include various apparatuses, including a desktop computer, a mobile computing apparatus, a notebook (for example, laptop) computer, a tablet computer, a set top box, a handheld telephone set such as a “smart” phone, a television set, a camera, a display apparatus, a digital media player, a video game console, a vehicle-mounted computer, a wireless communications device, or the like.

Although the source device 12 and the destination device 14 are depicted as separate devices in FIG. 1A, a device embodiment may alternatively include both the source device 12 and the destination device 14 or functionality of both, namely, the source device 12 or corresponding functionality and the destination device 14 or corresponding functionality. In such an embodiment, same hardware and/or software, separate hardware and/or software, or any combination thereof may be used to implement the source device 12 or the corresponding functionality and the destination device 14 or the corresponding functionality.

The source device 12 may be communicatively connected to the destination device 14 via a link 13, and the destination device 14 may receive the encoded video data from the source device 12 via the link 13. The link 13 may include one or more media and/or apparatuses that can move the encoded video data from the source device 12 to the destination device 14. In an instance, the link 13 may include one or more communications media that enable the source device 12 to directly transmit the encoded video data to the destination device 14 in real time. In this instance, the source device 12 may modulate the encoded video data according to a communications standard (for example, a wireless communications protocol), and may transmit modulated video data to the destination device 14. The one or more communications media may include wireless and/or wired communications media, for example, a radio frequency (RF) spectrum or one or more physical transmission lines. The one or more communications media may constitute a part of a packet-based network (the packet-based network is, for example, a local area network, a wide area network, or a global network (such as the Internet)). The one or more communications media may include a router, a switch, a base station, or another device that facilitates communication from the source device 12 to the destination device 14.

The source device 12 includes an encoder 20. In addition, in an embodiment, the source device 12 may further include a picture source 16, a picture preprocessor 18, and a communications interface 22. In an embodiment, the encoder 20, the picture source 16, the picture preprocessor 18, and the communications interface 22 may be hardware components in the source device 12 or may be software programs in the source device 12; and are separately described as follows:

The picture source 16 may include or may be any type of picture capture device configured to capture, for example, a real-world picture, and/or any type of picture or comment (for screen content encoding, some text on a screen is also considered as a part of a to-be-encoded picture or picture) generation device, for example, a computer graphics processing unit configured to generate a computer animated picture, or any other type of device configured to obtain and/or provide a real-world picture or a computer animated picture (for example, screen content or a virtual reality (VR) picture), and/or any combination thereof (for example, an augmented reality (AR) picture). The picture source 16 may be a camera configured to capture a picture or a memory configured to store a picture. The picture source 16 may further include any type of (internal or external) interface for storing a previously captured or generated picture and/or obtaining or receiving a picture. When the picture source 16 is a camera, the picture source 16 may be, for example, a local camera or an integrated camera integrated into the source device. When the picture source 16 is a memory, the picture source 16 may be, for example, a local memory or an integrated memory integrated into the source device. When the picture source 16 includes an interface, the interface may be, for example, an external interface for receiving a picture from an external video source. The external video source is, for example, an external picture capture device such as a camera, an external memory, or an external picture generation device. The external picture generation device is, for example, an external computer graphics processing unit, a computer, or a server. The interface may be any type of interface according to any dedicated or standardized interface protocol, such as a wired or wireless interface or an optical interface.

The picture may be considered as a two-dimensional array or matrix of picture elements (picture element). A picture element in an array may also be referred to as a sampling point. Quantities of sampling points in horizontal and vertical directions (or axes) of an array or a picture defines a size and/or resolution of the picture. To represent a color, three color components are usually used; in other words, a picture may be represented as or include three sampling arrays. For example, in an RGB format or color space, a picture includes corresponding red, green, and blue sampling arrays. However, in video encoding, each pixel is usually represented in a luma/chroma format or color space. For example, a picture in a YUV format includes a luma component indicated by Y (which sometimes may alternatively be indicated by L) and two chroma components indicated by U and V. The luma component Y represents luma or gray level intensity (for example, the luma and the gray level intensity are the same in a gray level picture), and the two chroma components U and V represent chroma or color information components. Correspondingly, the picture in the YUV format includes a luma sampling array of luma sampling values (Y) and two chroma sampling arrays of chroma values (U and V). A picture in an RGB format may be converted or transformed into a YUV format, and vice versa. This process is also referred to as color conversion or transform. If a picture is monochrome, the picture may include only a luma sampling array. In this embodiment of the present disclosure, a picture transmitted by the picture source 16 to the picture processor may also be referred to as original picture data 17.

The picture preprocessor 18 is configured to: receive the original picture data 17, and preprocess the original picture data 17, to obtain a preprocessed picture 19 or preprocessed picture data 19. For example, the preprocessing performed by the picture preprocessor 18 may include trimming, color format conversion (for example, conversion from an RGB format into a YUV format), color correction, or denoising.

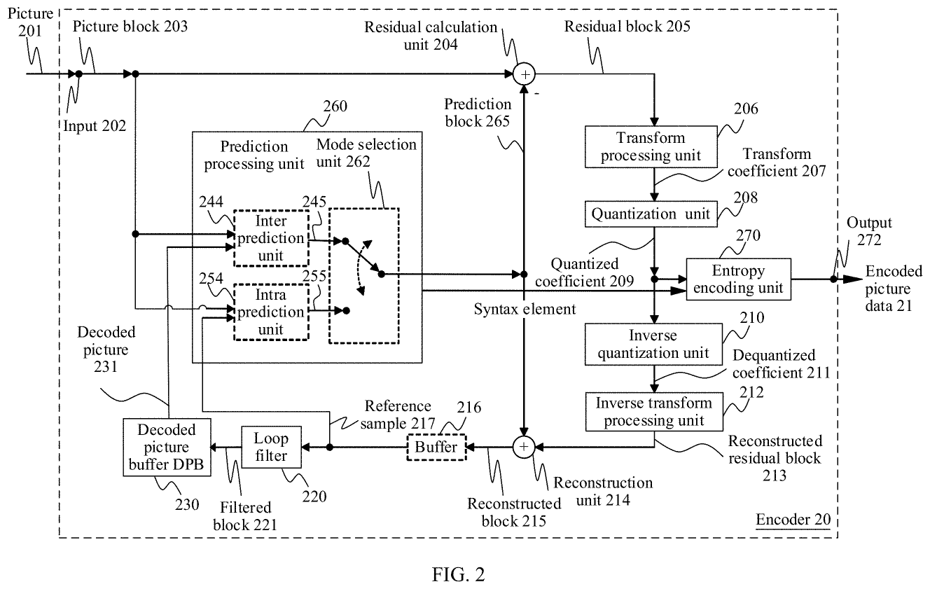

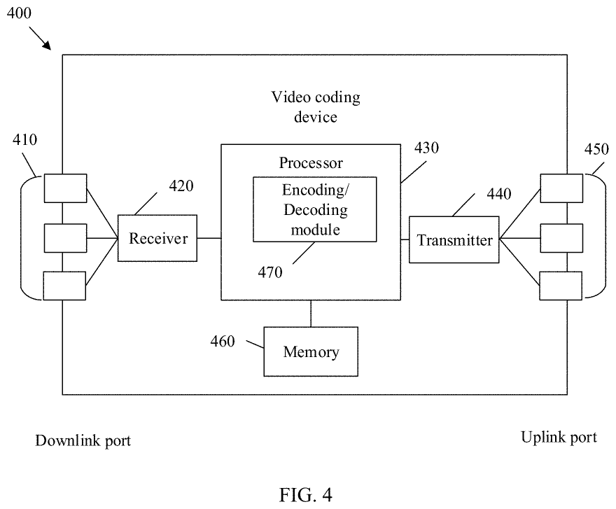

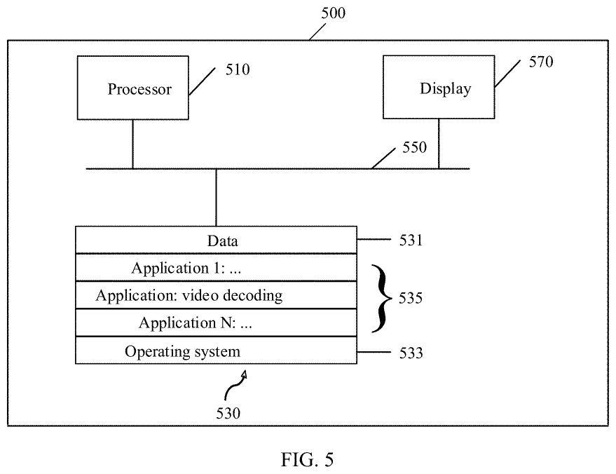

The encoder 20 is configured to: receive the preprocessed picture data 19, and process the preprocessed picture data 19 by using a related prediction mode (for example, a prediction mode described in the embodiments of the specification, for example, a multi-hypothesis encoding prediction mode), to provide encoded picture data 21 (structural details of the encoder 20 are further described below based on FIG. 2, FIG. 4, or FIG. 5). In some embodiments, the encoder 20 may be configured to perform related embodiments described subsequently, to implement application of the weighted prediction method for multi-hypothesis encoding described in the present disclosure to an encoder side.

The communications interface 22 may be configured to receive the encoded picture data 21, and may transmit the encoded picture data 21 to the destination device 14 or any other device (for example, a memory) via the link 13, for storage or direct reconstruction. The other device may be any device for decoding or storage. The communications interface 22 may be configured to encapsulate, for example, the encoded picture data 21 into an appropriate format such as a data packet, for transmission on the link 13.

The destination device 14 includes a decoder 30. In addition, in an embodiment, the destination device 14 may further include a communications interface 28, a picture postprocessor 32, and a display device 34; and are separately described as follows:

The communications interface 28 may be configured to receive the encoded picture data 21 from the source device 12 or any other source. The any other source is, for example, a storage device. The storage device is, for example, an encoded picture data storage device. The communications interface 28 may be configured to transmit or receive the encoded picture data 21 via the link 13 between the source device 12 and the destination device 14 or via any type of network. The link 13 is, for example, a direct wired or wireless connection. The any type of network is, for example, a wired or wireless network or any combination thereof, or any type of private or public network or any combination thereof. The communications interface 28 may be configured to decapsulate, for example, the data packet transmitted by the communications interface 22, to obtain the encoded picture data 21.

The communications interface 28 and the communications interface 22 each may be configured as a unidirectional communications interface or a bidirectional communications interface, and may be configured to: for example, send and receive messages to establish a connection, and acknowledge and exchange any other information related to the communications link and/or data transmission such as encoded picture data transmission.

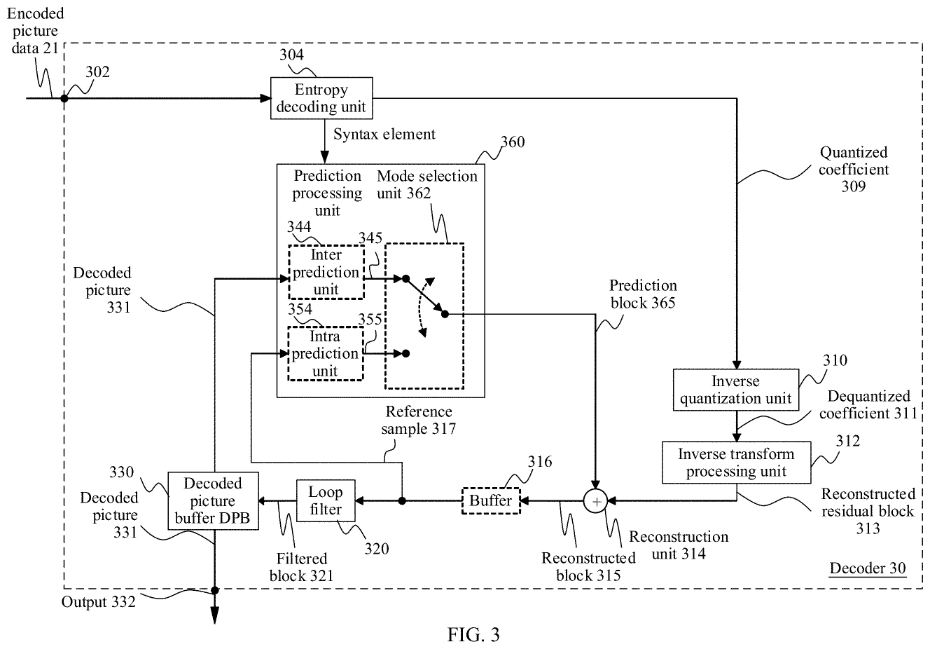

The decoder 30 is configured to: receive the encoded picture data 21, and provide decoded picture data 31 or a decoded picture 31 (structural details of the decoder 30 are further described below based on FIG. 3, FIG. 4, or FIG. 5). In some embodiments, the decoder 30 may be configured to perform related embodiments described subsequently, to implement application of the weighted prediction method for multi-hypothesis encoding described in the present disclosure to a decoder side.

The picture postprocessor 32 is configured to postprocess the decoded picture data 31 (also referred to as reconstructed picture data), to obtain postprocessed picture data 33. The postprocessing performed by the picture postprocessor 32 may include color format conversion (for example, conversion from a YUV format into an RGB format), color correction, trimming, resampling, or any other processing. The picture postprocessor 32 may be further configured to transmit the postprocessed picture data 33 to the display device 34.

The display device 34 is configured to receive the postprocessed picture data 33 to display a picture to, for example, a user or a viewer. The display device 34 may be or may include any type of display configured to present a reconstructed picture, for example, an integrated or external display or monitor. For example, the display may include a liquid crystal display (LCD), an organic light-emitting diode (OLED) display, a plasma display, a projector, a micro LED display, a liquid crystal on silicon (LCOS) display, a digital light processor (DLP), or any other type of display.

Although the source device 12 and the destination device 14 are depicted as separate devices in FIG. 1A, a device embodiment may alternatively include both the source device 12 and the destination device 14 or functionality of both, namely, the source device 12 or corresponding functionality and the destination device 14 or corresponding functionality. In such an embodiment, same hardware and/or software, separate hardware and/or software, or any combination thereof may be used to implement the source device 12 or the corresponding functionality and the destination device 14 or the corresponding functionality.

It may be clearly known to one of ordinary skilled in the art based on the description that, existence and (accurate) division of functionality of different units or the functionality of the source device 12 and/or the destination device 14 shown in FIG. 1A may vary based on actual devices and applications. The source device 12 and the destination device 14 each may include any one of various devices, including any type of handheld or stationary device, such as a notebook or laptop computer, a mobile phone, a smartphone, a tablet or tablet computer, a video camera, a desktop computer, a set top box, a television set, a camera, a vehicle-mounted device, a display device, a digital media player, a video game console, a video streaming device (such as a content server or a content delivery server), a broadcast receiver device, a broadcast transmitter device, and the like, and may not use or use any type of operating system.

The encoder 20 and the decoder 30 each may be implemented as any one of various appropriate circuits, such as one or more microprocessors, digital signal processors (DSP), application-specific integrated circuits (ASIC), field-programmable gate arrays (FPGA), discrete logic, hardware, or any combination thereof. If the technologies are partially implemented by using software, the device may store an instruction of the software in an appropriate non-transitory computer readable storage medium and may use one or more processors to execute the instruction by using hardware, to perform the technologies of this disclosure. Any one term of the foregoing content (including the hardware, the software, a combination of the hardware and the software, and the like) may be considered as one or more processors.

In some cases, the video encoding and decoding system 10 shown in FIG. 1A is merely an example, and the technologies of the present disclosure are applicable to video encoding setting (for example, video encoding or video decoding) that unnecessarily includes any data communication between an encoding device and a decoding device. In other instances, data may be retrieved from a local memory, streamed on a network, or the like. The video encoding device may encode data and store encoded data in a memory, and/or the video decoding device may retrieve the data from the memory and decode the data. In some instances, encoding and decoding are performed by devices that do not communicate with each other but only encode data and store encoded data in a memory and/or retrieve the data from the memory and decode the data.

FIG. 1B is a diagram illustrating an instance of a video coding system 40 including an encoder 20 in FIG. 2 and/or a decoder 30 in FIG. 3 according to an example embodiment. The video coding system 40 may implement a combination of various technologies in the embodiments of the present disclosure. In an embodiment, the video coding system 40 may include an imaging device 41, the encoder 20, the decoder 30 (and/or a video encoder/decoder implemented by using a logic circuit 47 in a processing unit 46), an antenna 42, one or more processors 43, one or more memories 44, and/or a display device 45.

As shown in FIG. 1B, the imaging device 41, the antenna 42, the processing unit 46, the logic circuit 47, the encoder 20, the decoder 30, the processor 43, the memory 44, and/or the display device 45 can communicate with each other. As discussed, although the video coding system 40 is depicted with the encoder 20 and the decoder 30, in different instances, the video coding system 40 may include only the encoder 20 or the decoder 30.

In some instances, the antenna 42 may be configured to transmit or receive an encoded bitstream of video data. In addition, in some instances, the display device 45 may be configured to present video data. In some instances, the logic circuit 47 may be implemented by using the processing unit 46. The processing unit 46 may include application-specific integrated circuit (ASIC) logic, a graphics processing unit, a general purpose processor, and the like. The video coding system 40 may also include the optional processor 43. The optional processor 43 similarly may include application-specific integrated circuit (ASIC) logic, a graphics processing unit, a general purpose processor, and the like. In some instances, the logic circuit 47 may be implemented by using hardware such as hardware dedicated to video encoding, and the processor 43 may be implemented by using general service software, an operating system, or the like. In addition, the memory 44 may be any type of memory, such as a volatile memory (for example, a static random access memory (SRAM) or a dynamic random access memory (DRAM), or a nonvolatile memory (for example, a flash memory). In a non-limitative instance, the memory 44 may be implemented by using a cache memory. In some instances, the logic circuit 47 may access the memory 44 (to implement, for example, a picture buffer). In other instances, the logic circuit 47 and/or the processing unit 46 may include a memory (for example, a cache) to implement a picture buffer or the like.

In some instances, the encoder 20 implemented by using the logic circuit may include a picture buffer (implemented by using, for example, the processing unit 46 or the memory 44) and a graphics processing unit (implemented by using, for example, the processing unit 46). The graphics processing unit may be communicatively coupled to the picture buffer. The graphics processing unit may include the encoder 20 implemented by using the logic circuit 47, to implement various modules described with reference to FIG. 2 and/or any other encoder system or subsystem described in this specification. The logic circuit may be configured to perform various operations described in this specification.

In some instances, the decoder 30 may be implemented in a similar manner by using the logic circuit 47, to implement various modules described with reference to the decoder 30 in FIG. 3 and/or any other decoder system or subsystem described in this specification. In some instances, the decoder 30 implemented by using the logic circuit may include a picture buffer (implemented by using the processing unit 46 or the memory 44) and a graphics processing unit (implemented by using, for example, the processing unit 46). The graphics processing unit may be communicatively coupled to the picture buffer. The graphics processing unit may include the decoder 30 implemented by using the logic circuit 47, to implement various modules described with reference to FIG. 3 and/or any other decoder system or subsystem described in this specification.

In some instances, the antenna 42 may be configured to receive an encoded bitstream of video data. As discussed, the encoded bitstream may include data, an indicator, an index value, mode selection data, and the like related to an encoded video frame that are discussed in this specification, such as data related to encoding partitioning (for example, a transform coefficient or a quantized transform coefficient, (as discussed) an optional indicator, and/or data defining encoding partitioning). The video coding system 40 may further include the decoder 30 that is coupled to the antenna 42 and configured to decode the encoded bitstream. The display device 45 is configured to present a video frame.

It should be understood that, in this embodiment of the present disclosure, for an instance described with reference to the encoder 20, the decoder 30 may be configured to perform an inverse process. With respect to a signaling syntax element, the decoder 30 may be configured to: receive and parse such a syntax element, and correspondingly decode related video data. In some examples, the encoder 20 may entropically encode a syntax element as an encoded video bitstream. In such instances, the decoder 30 may parse such a syntax element, and correspondingly decode related video data.

It should be noted that the method described in the embodiments of the present disclosure is mainly used in an inter prediction process. This process exists in both the encoder 20 and the decoder 30. In this embodiment of the present disclosure, the encoder 20 and the decoder 30 may be an encoder/decoder corresponding to a video standard protocol such as H.263, H.264, HEVC, MPEG-2, MPEG-4, VP8, or VP9, or a next-generation video standard protocol (such as H.266).

FIG. 2 is a schematic/conceptual block diagram of an instance of an encoder 20 for implementing an embodiment of the present disclosure. In the instance in FIG. 2, the encoder 20 includes a residual calculation unit 204, a transform processing unit 206, a quantization unit 208, an inverse quantization unit 210, an inverse transform processing unit 212, a reconstruction unit 214, a buffer 216, a loop filter unit 220, a decoded picture buffer (DPB) 230, a prediction processing unit 260, and an entropy coding unit 270. The prediction processing unit 260 may include an inter prediction unit 244, an intra prediction unit 254, and a mode selection unit 262. The inter prediction unit 244 may include a motion estimation unit and a motion compensation unit (not shown). The encoder 20 shown in FIG. 2 may also be referred to as a hybrid video encoder or a video encoder according to a hybrid video encoder/decoder.

For example, the residual calculation unit 204, the transform processing unit 206, the quantization unit 208, the prediction processing unit 260, and the entropy coding unit 270 constitute a forward signal path of the encoder 20. In addition, for example, the inverse quantization unit 210, the inverse transform processing unit 212, the reconstruction unit 214, the buffer 216, the loop filter 220, the decoded picture buffer (DPB) 230, and the prediction processing unit 260 constitute a backward signal path of the encoder. The backward signal path of the encoder corresponds to a signal path of a decoder (refer to a decoder 30 in FIG. 3).

The encoder 20 receives a picture 201 or a picture block 203 of the picture 201, for example, a picture in a picture sequence constituting a video or video sequence, by using, for example, an input 202. The picture block 203 may also be referred to as a current encoding block or a to-be-processed picture block. The picture 201 may be referred to as a current picture or a to-be-encoded picture (especially in video encoding, when a current picture is distinguished from another picture, the another picture is, for example, a previously encoded and/or decoded picture in a same video sequence, namely, a video sequence also including the current picture).

An embodiment of the encoder 20 may include a partitioning unit (not depicted in FIG. 2) configured to partition the picture 201 into a plurality of blocks such as the picture block 203, and typically partition the picture 201 into a plurality of non-overlapping blocks. The partitioning unit may be configured to: use a same block size and corresponding grid for all pictures in a video sequence, where the corresponding grid defines the block size, or change a block size within a picture, subset, or picture group; and partition each picture into corresponding blocks.

In an instance, the prediction processing unit 260 in the encoder 20 may be configured to perform any combination of the foregoing partitioning technologies.

Like the picture 201, the picture block 203 is also or may be considered as a two-dimensional array or matrix of sampling points with sampling values, although a size of the picture block 203 is smaller than that of the picture 201. In other words, the picture block 203 may include, for example, one sampling array (for example, one luma array in a case of a monochrome picture 201), three sampling arrays (for example, one luma array and two chroma arrays in a case of a color picture), or any other quantity and/or category of arrays according to an applied color format. Quantities of sampling points in horizontal and vertical directions (or axes) of the picture block 203 defines the size of the picture block 203.

The encoder 20 shown in FIG. 2 is configured to encode the picture 201 block by block, for example, encode and predict each picture block 203.

The residual calculation unit 204 is configured to calculate a residual block 205 based on the picture block 203 and a prediction block 265 (other details of the prediction block 265 are provided below). For example, sample values of the prediction block 265 are subtracted from sample values of the picture block 203 sample by sample (pixel by pixel) to obtain the residual block 205 in sample domain.

The transform processing unit 206 is configured to apply transform such as discrete cosine transform (DCT) or discrete sine transform (DST) to a sample value of the residual block 205, to obtain a transform coefficient 207 in transform domain. The transform coefficient 207 may also be referred to as a transform residual coefficient, and represents the residual block 205 in transform domain.

The transform processing unit 206 may be configured to apply an integer approximation of DCT/DST, for example, transform specified for HEVC/H.265. Compared with orthogonal DCT, such an integer approximation is usually scaled based on a factor. To maintain norms of residual blocks obtained after forward transform processing and inverse transform processing, additional scaling factors are applied as parts of transform processes. The scaling factor is usually selected based on some constraints. For example, the scaling factor is the power of 2 for a shift operation, a bit depth of a transform coefficient, or a tradeoff between accuracy and implementation costs. For example, a scaling factor is specified for inverse transform on a decoder 30 side by using, for example, the inverse transform processing unit 212 (a scaling factor is specified for corresponding inverse transform on an encoder 20 side by using, for example, the inverse transform processing unit 212), and correspondingly, a corresponding scaling factor may be specified for forward transform on the encoder 20 side by using the transform processing unit 206.

The quantization unit 208 is configured to quantize the transform coefficient 207 by applying, for example, scalar quantization or vector quantization, to obtain a quantized transform coefficient 209. The quantized transform coefficient 209 may also be referred to as a quantized residual coefficient 209. The quantization process may reduce a bit depth related to a part or all of the transform coefficient 207. For example, an n-bit transform coefficient may be rounded down to an m-bit transform coefficient during quantization, where n is greater than m. A quantization degree may be modified by adjusting a quantization parameter (QP). For example, for the scalar quantization, different scales may be applied to achieve finer or coarser quantization. A smaller quantization operation corresponds to finer quantization, and a larger quantization operation corresponds to coarser quantization. An appropriate quantization operation may be indicated by using the quantization parameter (QP). For example, the quantization parameter may be an index of a predefined set of appropriate quantization operations. For example, a smaller quantization parameter may correspond to fine quantization (a smaller quantization operation), and a larger quantization parameter may correspond to coarse quantization (a larger quantization operation); and vice versa. The quantization may include dividing by a quantization operation and corresponding quantization or inverse quantization performed by using, for example, the inverse quantization unit 210, or may include multiplying by a quantization operation. The quantization operation may be determined by using a quantization parameter according to embodiments of some standards such as HEVC. In general, the quantization operation may be calculated based on the quantization parameter by using fixed point approximation of an equation including division. Additional scaling factors may be introduced for quantization and dequantization to recover norms that are of residual blocks and that may be modified due to scales used in the fixed point approximation of the equation for the quantization operation and the quantization parameter. In an embodiment, scales of inverse transform and dequantization may be combined. Alternatively, a custom quantization table may be used and sent from the encoder to the decoder in, for example, a bitstream by using a signal. The quantization is a lossy operation, and a larger quantization operation indicates a larger loss.

The inverse quantization unit 210 is configured to apply, to the quantized coefficient, inverse quantization of the quantization applied by the quantization unit 208, for example, apply, to the quantized coefficient based on or by using a quantization operation that is the same as that used by the quantization unit 208, an inverse quantization scheme of a quantization scheme applied by the quantization unit 208, to obtain a dequantized coefficient 211. The dequantized coefficient 211 may also be referred to as a dequantized residual coefficient 211, and corresponds to the transform coefficient 207, although the dequantized coefficient 211 is usually different from the transform coefficient due to a loss caused by the quantization.

The inverse transform processing unit 212 is configured to apply inverse transform of the transform applied by the transform processing unit 206, such as inverse discrete cosine transform (DCT) or inverse discrete sine transform (DST), to obtain an inverse transform block 213 in sample domain. The inverse transform block 213 may also be referred to as an inverse transform dequantized block 213 or an inverse transform residual block 213.

The reconstruction unit 214 (for example, a summer 214) is configured to add the inverse transform block 213 (namely, a reconstructed residual block 213) to the prediction block 265 by, for example, adding a sample value of the reconstructed residual block 213 to a sample value of the prediction block 265, to obtain a reconstructed block 215 in sample domain.

In an embodiment, the buffer unit 216 (or referred to as the “buffer” 216) such as a line buffer 216 is configured to buffer or store the reconstructed block 215 and a corresponding sample value, for, for example, intra prediction. In another embodiment, the encoder may be configured to perform any type of estimation and/or prediction such as intra prediction by using an unfiltered reconstructed block and/or a corresponding sample value that are/is stored in the buffer unit 216.

For example, an embodiment of the encoder 20 may be configured to enable the buffer unit 216 to be not only configured to store the reconstructed block 215 used by the intra prediction unit 254, but also used for the loop filter unit 220, and/or enable the buffer unit 216 and the decoded picture buffer unit 230 to constitute a buffer. Another embodiment may be configured to use a filtered block 221 and/or a block or sample from the decoded picture buffer 230 (neither the block nor the sample is shown in FIG. 2) as input or a basis for the intra prediction unit 254.

The loop filter unit 220 (or referred to as the “loop filter” 220) is configured to filter the reconstructed block 215 to obtain the filtered block 221, thereby smoothly performing pixel transform or improving video quality. The loop filter unit 220 is intended to represent one or more loop filters, such as a deblocking filter, a sample-adaptive offset (SAO) filter, or another filter such as a bilateral filter, an adaptive loop filter (ALF), a sharpening or smoothing filter, or a collaborative filter. Although the loop filter unit 220 is shown as an in loop filter in FIG. 2, in another configuration, the loop filter unit 220 may be implemented as a post loop filter. The filtered block 221 may also be referred to as a filtered reconstructed block 221. The decoded picture buffer 230 may store the reconstructed encoding block after the loop filter unit 220 performs a filtering operation on the reconstructed encoding block.

An embodiment of the encoder 20 (correspondingly, the loop filter unit 220) may be configured to output a loop filter parameter (for example, sample-adaptive offset information), for example, directly output the loop filter parameter or output an encoded loop filter parameter obtained after the entropy coding unit 270 or any other entropy coding unit entropically encodes the loop filter parameter, to, for example, enable the decoder 30 to receive and apply the same loop filter parameter for decoding.

The decoded picture buffer (DPB) 230 may be a reference picture memory for storing reference picture data for encoding video data by the encoder 20. The DPB 230 may include any one of a plurality of storage devices, such as a dynamic random access memory (DRAM) (including a synchronous DRAM (SDRAM), a magnetoresistive RAM (MRAM), and a resistive RAM (RRAM)) or another type of storage device. The DPB 230 and the buffer 216 may be provided by using a same storage device or separate storage devices. In an instance, the decoded picture buffer (DPB) 230 is configured to store the filtered block 221. The decoded picture buffer 230 may be further configured to store another previous filtered block of the same current picture or a different picture such as a previous reconstructed picture, for example, a previous reconstructed and filtered block 221, and may provide a complete previous reconstructed, namely, decoded picture (and a corresponding reference block and sample) and/or a partially reconstructed current picture (and a corresponding reference block and sample), for, for example, inter prediction. In an instance, if the reconstructed block 215 is reconstructed without in loop filtering, the decoded picture buffer (DPB) 230 is configured to store the reconstructed block 215.

The prediction processing unit 260 is also referred to as a block prediction processing unit 260, and is configured to: receive or obtain the picture block 203 (the current picture block 203 of the current picture 201) and reconstructed picture data such as a reference sample of the same (current) picture from the buffer 216 and/or reference picture data 231 of one or more previous decoded pictures from the decoded picture buffer 230, and process such data for prediction; in other words, provide the prediction block 265 that may be an inter prediction block 245 or an intra prediction block 255.

The mode selection unit 262 may be configured to select a prediction mode (such as an intra or inter prediction mode) and/or the corresponding prediction block 245 or 255 used as the prediction block 265, to calculate the residual block 205 and reconstruct the reconstructed block 215.

An embodiment of the mode selection unit 262 may be used to select a prediction mode (from, for example, those prediction modes supported by the prediction processing unit 260). In the prediction mode, best matching or a minimum residual (the minimum residual means better compression in transmission or storage) is provided, minimum signaling overheads (the minimum signaling overheads mean better compression in transmission or storage) are provided, or both are considered or balanced. The mode selection unit 262 may be configured to determine a prediction mode based on rate-distortion optimization (RDO); in other words, select a prediction mode that provides minimum rate-distortion optimization, or select a prediction mode in which related rate-distortion meets at least a prediction mode selection criterion. In a multi-hypothesis encoding prediction scenario described in this embodiment of the present disclosure, prediction of the current block includes both inter prediction and intra prediction. Correspondingly, the mode selection unit 262 may separately select the inter prediction unit 244 and the intra prediction unit 254 to perform encoding prediction.

The following describes in detail prediction processing performed (for example, by using the prediction processing unit 260) and mode selection performed (for example, by using the mode selection unit 262) in the instance of the encoder 20.

As described above, the encoder 20 is configured to determine or select a best or optimal prediction mode from a (predetermined) prediction mode set. The prediction mode set may include, for example, an intra prediction mode and/or an inter prediction mode. Correspondingly, the intra prediction mode may be performed by using the intra prediction unit 254, and the inter prediction mode may be performed by using the inter prediction unit 244.

The intra prediction unit 254 is configured to obtain the picture block 203 (current block) of the same picture and one or more previous reconstructed blocks such as reconstructed neighboring blocks, for intra estimation. In an instance, the encoder 20 may be configured to select an intra prediction mode from a plurality of intra prediction modes to perform intra estimation. In another instance, the encoder 20 may directly use some preset intra prediction modes to perform intra estimation (for example, the preset intra prediction mode is a planar mode).

In an embodiment, for a luma block (or referred to as a luma component), an intra prediction mode set (for example, an intra candidate list) may include four intra prediction modes: a planar mode, a vertical mode, a horizontal mode, and a DC mode. A size of the intra candidate list may be selected based on a shape of the current block, and may include three or four modes. When a width of the current block is twice greater than a height of the current block, the intra candidate list may not include the horizontal mode; or when a height of the current block is twice greater than a width of the current block, the intra candidate list may not include the vertical mode. For a chroma block (or referred to as a chroma component), a DM mode is used; in other words, a prediction mode that is the same as that used for the luma component is used.

In an embodiment, in a next-generation video encoding standard (such as H.266), an intra prediction mode of a chroma component of a picture further includes a cross component prediction (CCP) mode. The cross component prediction (CCP) mode is also referred to as a cross component intra prediction (CCIP) mode or a cross component linear mode (CCLM). The CCLM prediction mode may also be referred to as a linear model mode (LM mode for short).

In an embodiment, for a luma component of a picture, an intra prediction mode set may alternatively include 35 different intra prediction modes, including 33 direction prediction modes, a DC prediction mode, and a planar prediction mode. The direction prediction mode is mapping a reference pixel to a picture element location in a current block in a direction (marked by using an intra mode index) to obtain a prediction value of a current picture element; or for each picture element in a current block, inversely mapping a location of the picture element to a reference pixel in a direction (marked by using an intra mode index), where a pixel value of the corresponding reference pixel is a prediction value of the current pixel. Unlike the direction prediction mode, the DC prediction is using an average value of reference pixels as a prediction value of a pixel in a current block. The planar mode is jointly deriving a prediction value of a current picture element by using pixel values of reference picture elements directly above and directly to the left of the current picture element and pixel values of above-right and bottom-left reference picture elements of a current block.

The intra prediction unit 254 is further configured to determine the intra prediction block 255 (or referred to as a motion compensation block 255) based on, for example, an intra prediction parameter of the selected intra prediction mode. In any case, after selecting the intra prediction mode for the block, the intra prediction unit 254 is further configured to provide the intra prediction parameter, namely, information indicating the selected intra prediction mode for the block, to the entropy coding unit 270.

In a possible embodiment, the intra prediction unit 254 may further include a filter set. The filter set includes a plurality of filter types, different filter types respectively represent different luma block downsampling algorithms, and each filter type corresponds to one chroma point sampling location. The intra prediction unit 254 may be further configured to: determine a sampling location of a chroma point in a current video sequence, determine, based on the sampling location of the chroma point, a filter type used for current encoding, and generate indication information based on the filter type. The indication information is used to indicate a filter type used for a luma picture downsampling process in the intra prediction mode when the current video sequence is encoded or decoded (for example, when the picture 201 or the picture block 203 is encoded or reconstructed). The intra prediction unit 254 is further configured to provide the indication information of the filter type to the entropy coding unit 270.

For example, the intra prediction unit 254 may transmit a syntax element to the entropy coding unit 270. The syntax element includes the intra prediction parameter (for example, indication information of the intra prediction mode that is used for prediction of the current block and that is selected after the plurality of intra prediction modes are traversed); and optionally, further includes the indication information of the filter type. In a possible application scenario, if there is only one intra prediction mode, the intra prediction parameter may not be carried in the syntax element. In this case, the decoder end 30 may directly use a default prediction mode to perform decoding.

The inter prediction unit 244 is configured to obtain the picture block 203 (current block) and one or more reference pictures, for inter estimation. In an instance, the encoder 20 may be configured to select an inter prediction mode from a plurality of inter prediction modes to perform inter estimation. In another instance, the encoder 20 may directly use some preset inter prediction modes to perform inter estimation.

In an embodiment, an inter prediction mode set depends on an available reference picture (namely, for example, the foregoing at least partially decoded picture stored in the DPB 230) and another inter prediction parameter, for example, depends on whether the entire reference picture or only a part of the reference picture is used, for example, a best matched reference block is searched for around a search window area of an area of the current block, and/or depends on whether pixel interpolation such as half-pixel and/or quarter-pixel interpolation is applied. The inter prediction mode set may include, for example, an advanced motion vector prediction (AMVP) mode and a merge mode. In this embodiment of the present disclosure, unidirectional prediction (forward or backward), bidirectional prediction (forward and backward), or multidirectional prediction may be applied to inter prediction of the to-be-processed picture block.

In addition to the prediction modes, a skip mode and/or a direct mode may also be applied to this embodiment of the present disclosure.

For example, the inter prediction unit 244 may transmit a syntax element to the entropy coding unit 270. The syntax element includes an inter prediction parameter (for example, indication information of the inter prediction mode that is used for prediction of the current block and that is selected after the plurality of inter prediction modes are traversed) and an index number of a candidate motion vector list; and optionally, further includes a reference index and the like. In a possible application scenario, if there is only one inter prediction mode, the inter prediction parameter may not be carried in the syntax element. In this case, the decoder end 30 may directly use a default prediction mode to perform decoding.

The prediction processing unit 260 may be further configured to partition the picture block 203 into smaller block partitions or sub-blocks, for example, by iteratively using quad-tree (QT) partitioning, binary-tree (BT) partitioning, or triple-tree (TT) partitioning, or any combination thereof, and configured to predict, for example, each of the block partitions or sub-blocks. Mode selection includes selecting a tree structure of the partitioned picture block 203 and selecting a prediction mode applied to each of the block partitions or sub-blocks.

The inter prediction unit 244 may include a motion estimation (ME) unit (not shown in FIG. 2) and a motion compensation (MC) unit (not shown in FIG. 2). The motion estimation unit is configured to: receive or obtain the picture block 203 (the current picture block 203 of the current picture 201) and the decoded picture 231, or at least one or more previous reconstructed blocks, for example, one or more reconstructed blocks of another/a different previous decoded picture 231, and perform motion estimation based on the determined inter prediction mode. For example, a video sequence may include a current picture and a previous decoded picture 231; in other words, the current picture and the previous decoded picture 231 may be parts of a picture sequence constituting the video sequence, or constitute the picture sequence.

For example, the encoder 20 may be configured to: select a reference block from a plurality of reference blocks of a same picture or different pictures in a plurality of other pictures (reference pictures), and provide a reference picture and/or an offset (spatial offset) between a location (X and Y coordinates) of the reference block and a location of the current block to the motion estimation unit (not shown in FIG. 2) as an inter prediction parameter. The offset is also referred to as a motion vector (MV).

The motion compensation unit is configured to: obtain the inter prediction parameter, and perform inter prediction based on or by using the inter prediction parameter, to obtain the inter prediction block 245. Motion compensation performed by the motion compensation unit (not shown in FIG. 2) may include extracting or generating a prediction block (prediction value) based on a motion block/vector determined through motion estimation (interpolation for sub pixel accuracy may be performed). Interpolation filtering can generate an additional pixel sample from a known pixel sample, to potentially increase a quantity of candidate prediction blocks available for picture block encoding. Once a motion vector for a PU of the current picture block is received, the motion compensation unit may locate a prediction block to which the motion vector points in a reference picture list. The motion compensation unit 246 may further generate a syntax element associated with a block and a video strip, to be used when the decoder 30 decodes a picture block of the video strip.

The entropy coding unit 270 is configured to: apply (or skip applying) an entropy encoding algorithm or scheme (such as a variable length coding (VLC) scheme, a context-adaptive VLC (CAVLC) scheme, an arithmetic encoding scheme, context-adaptive binary arithmetic coding (CABAC), syntax-based context-adaptive binary arithmetic coding (SBAC), probability interval partitioning entropy (PIPE) encoding, or another entropy encoding method or technology) to one or all of the quantized residual coefficient 209, the inter prediction parameter, the intra prediction parameter, and/or the loop filter parameter, to obtain encoded picture data 21 that may be output in a form of, for example, an encoded bitstream 21 by using an output 272. The encoded bitstream may be transmitted to the decoder 30, or archived for subsequent transmission or retrieval by the decoder 30. The entropy coding unit 270 may be further configured to entropically encode another syntax element of a current video strip that is being encoded.

Other structural variations of the encoder 20 may be configured to encode a video stream. For example, a non-transform-based encoder 20 may directly quantize a residual signal without the transform processing unit 206 for some blocks or frames. In an embodiment, the encoder 20 may have a quantization unit 208 and an inverse quantization unit 210 that are combined into a single unit.

In an embodiment, the encoder 20 may be configured to implement the weighted prediction method for multi-hypothesis encoding described in the subsequent embodiments.

It should be understood that other structural variations of the encoder 20 may be configured to encode a video stream. For example, for some picture blocks or picture frames, the encoder 20 may directly quantize residual signals without processing by the transform processing unit 206, and correspondingly, without processing by the inverse transform processing unit 212; or for some picture blocks or picture frames, the encoder 20 does not generate residual data, and correspondingly, the transform processing unit 206, the quantization unit 208, the inverse quantization unit 210, and the inverse transform processing unit 212 do not need to perform processing; or the encoder 20 may directly store a reconstructed picture block as a reference block without processing by the filter 220; or the quantization unit 208 and the inverse quantization unit 210 in the encoder 20 may be combined. The loop filter 220 is optional, and in a case of lossless compression encoding, the transform processing unit 206, the quantization unit 208, the inverse quantization unit 210, and the inverse transform processing unit 212 are optional. It should be understood that, the inter prediction unit 244 and the intra prediction unit 254 may be selectively enabled based on different application scenarios.

FIG. 3 is a schematic/conceptual block diagram of an instance of a decoder 30 for implementing an embodiment of the present disclosure. The decoder 30 is configured to receive, for example, encoded picture data (for example, an encoded bitstream) 21 encoded by an encoder 20, to obtain a decoded picture 231. In a decoding process, the decoder 30 receives video data, for example, an encoded video bitstream representing a picture block of an encoded video strip and an associated syntax element from the encoder 20.

In the instance in FIG. 3, the decoder 30 includes an entropy decoding unit 304, an inverse quantization unit 310, an inverse transform processing unit 312, a reconstruction unit 314 (for example, a summer 314), a buffer 316, a loop filter 320, a decoded picture buffer 330, and a prediction processing unit 360. The prediction processing unit 360 may include an inter prediction unit 344, an intra prediction unit 354, and a mode selection unit 362. In some instances, the decoder 30 may perform decoding substantially inverse to the encoding described with reference to the encoder 20 in FIG. 2.

The entropy decoding unit 304 is configured to entropically decode the encoded picture data 21 to obtain, for example, a quantized coefficient 309 and/or a decoded encoding parameter (not shown in FIG. 3), for example, any (decoded) one or all of an inter prediction parameter, an intra prediction parameter, a loop filter parameter, and/or another syntax element. The entropy decoding unit 304 is further configured to forward the inter prediction parameter, the intra prediction parameter, and/or the another syntax element to the prediction processing unit 360. The decoder 30 may receive a syntax element at a video strip level and/or a syntax element at a video block level.

The inverse quantization unit 310 may be functionally the same as the inverse quantization unit 210, the inverse transform processing unit 312 may be functionally the same as the inverse transform processing unit 212, the reconstruction unit 314 may be functionally the same as the reconstruction unit 214, the buffer 316 may be functionally the same as the buffer 216, the loop filter 320 may be functionally the same as the loop filter 220, and the decoded picture buffer 330 may be functionally the same as the decoded picture buffer 230.

The prediction processing unit 360 may include the inter prediction unit 344 and the intra prediction unit 354. The inter prediction unit 344 may be functionally similar to the inter prediction unit 244, and the intra prediction unit 354 may be functionally similar to the intra prediction unit 254. The prediction processing unit 360 is usually configured to: perform block prediction and/or obtain a prediction block 365 from the encoded data 21, and (explicitly or implicitly) receive or obtain a prediction-related parameter and/or information about a selected prediction mode from, for example, the entropy decoding unit 304.

When a video strip is encoded as an intra encoded (I) strip, the intra prediction unit 354 in the prediction processing unit 360 is configured to generate a prediction block 365 for a picture block of the current video strip based on an intra prediction mode represented by a signal and based on data from a previous decoded block of a current frame or picture. When a video frame is encoded as an inter encoded (namely, B or P) strip, the inter prediction unit 344 (for example, a motion compensation unit) in the prediction processing unit 360 is configured to generate a prediction block 365 for a video block of the current video strip based on a motion vector and the another syntax element received from the entropy decoding unit 304. For inter prediction, a prediction block may be generated from a reference picture in a reference picture list. The decoder 30 may construct reference picture lists: a list 0 and a list 1 by using a default construction technology based on a reference picture stored in the DPB 330.

The prediction processing unit 360 is configured to: parse the motion vector and the another syntax element to determine prediction information for the video block of the current video strip, and generate, by using the prediction information, the prediction block for the current video block that is being decoded. In an instance of the present disclosure, the prediction processing unit 360 determines a prediction mode (for example, a multi-hypothesis encoding prediction mode with a joint intra prediction mode and inter prediction mode) for the video block of the encoded video strip, an inter prediction strip type (for example, a B strip, a P strip, or a GPB strip), construction information for one or more of reference picture lists for the strip, a motion vector of each inter encoded video block for the strip, an inter prediction state of each inter encoded video block of the strip, and other information by using some received syntax elements, to decode the video block of the current video strip. In another instance of this disclosure, a syntax element received by the decoder 30 from a bitstream includes a syntax element in one or more of an adaptive parameter set (APS), a sequence parameter set (SPS), a picture parameter set (PPS), or a strip header.

The inverse quantization unit 310 may be configured to inversely quantize (namely, dequantize) the quantized transform coefficient that is provided in the bitstream and that is obtained through decoding by the entropy decoding unit 304. An inverse quantization process may include determining, by using a quantization parameter calculated by the encoder 20 for each video block of the video strip, a quantization degree that should be applied, and likewise determining an inverse quantization degree that should be applied.

The inverse transform processing unit 312 is configured to apply inverse transform (for example, inverse DCT, inverse integer transform, or a conceptually similar inverse transform process) to a transform coefficient, to generate a residual block in pixel domain.

The reconstruction unit 314 (for example, the summer 314) is configured to add an inverse transform block 313 (namely, a reconstructed residual block 313) to the prediction block 365 by, for example, adding a sample value of the reconstructed residual block 313 to a sample value of the prediction block 365, to obtain a reconstructed block 315 in sample domain.

The loop filter unit 320 is configured to filter the reconstructed block 315 (during an encode loop or after the encode loop) to obtain a filtered block 321, thereby smoothly performing pixel transform or improving video quality. In an instance, the loop filter unit 320 may be configured to perform any combination of filtering technologies described below. The loop filter unit 320 is intended to represent one or more loop filters, such as a deblocking filter, a sample-adaptive offset (SAO) filter, or another filter such as a bilateral filter, an adaptive loop filter (ALF), a sharpening or smoothing filter, or a collaborative filter. Although the loop filter unit 320 is shown as an in loop filter in FIG. 3, in another configuration, the loop filter unit 320 may be implemented as a post loop filter.

Then, the decoded video block 321 in the given frame or picture is stored in the decoded picture buffer 330 storing a reference picture for subsequent motion compensation.

The decoder 30 is configured to output a decoded picture 331 by using, for example, an output 332, for presentation to a user or for the user to view.

Other variations of the decoder 30 may be configured to decode a compressed bitstream. For example, the decoder 30 may generate an output video stream without the loop filter unit 320. For example, a non-transform-based decoder 30 may directly inversely quantize a residual signal without the inverse transform processing unit 312 for some blocks or frames. In an embodiment, the decoder 30 may have an inverse quantization unit 310 and an inverse transform processing unit 312 that are combined into a single unit.

It should be understood that other structural variations of the decoder 30 may be configured to decode an encoded video bitstream. For example, the decoder 30 may generate an output video stream without processing by the filter 320; or for some picture blocks or picture frames, the entropy decoding unit 304 in the decoder 30 does not obtain quantized coefficients through decoding, and correspondingly, the inverse quantization unit 310 and the inverse transform processing unit 312 do not need to perform processing. The loop filter 320 is optional, and in a case of lossless compression, the inverse quantization unit 310 and the inverse transform processing unit 312 are optional. It should be understood that, the inter prediction unit and the intra prediction unit may be selectively enabled based on different application scenarios.

In an embodiment, the decoder 30 may be configured to implement the weighted prediction method for multi-hypothesis encoding described in the subsequent embodiments.

For example, the decoder 30 may be configured to: determine a first target prediction block of a to-be-processed picture block by using an inter prediction mode; determine a second target prediction block of the to-be-processed picture block by using an intra prediction mode; determine, based on indication information in a bitstream, weight coefficients respectively corresponding to the inter prediction mode and the intra prediction mode; and weight a pixel value of the first target prediction block and a pixel value of the second target prediction block based on the weight coefficients, to obtain a prediction value of the to-be-processed picture block.

When a residual picture for the to-be-processed picture block in the inter prediction mode is not transmitted in the bitstream, or when motion compensation does not need to be performed in the inter prediction mode, the first target prediction block represents a prediction block obtained by predicting the to-be-processed picture block by using the inter prediction mode.

When a residual picture for the to-be-processed picture block in the inter prediction mode is transmitted in the bitstream, or when motion compensation needs to be performed in the inter prediction mode, the first target prediction block represents a picture block obtained by performing motion compensation on a prediction block after the prediction block is obtained by predicting the to-be-processed picture block by using the inter prediction mode.

When a residual picture for the to-be-processed picture block in the intra prediction mode is not transmitted in the bitstream, or when motion compensation does not need to be performed in the intra prediction mode, the second target prediction block represents a prediction block obtained by predicting the to-be-processed picture block by using the intra prediction mode.

When a residual picture for the to-be-processed picture block in the intra prediction mode is transmitted in the bitstream, or when motion compensation needs to be performed in the intra prediction mode, the second target prediction block represents a picture block obtained by performing motion compensation on a prediction block after the prediction block is obtained by predicting the to-be-processed picture block by using the intra prediction mode.

FIG. 4 is a schematic structural diagram of a video coding device 400 (for example, a video encoding device 400 or a video decoding device 400) according to an embodiment of the present disclosure. The video coding device 400 is adapted to implement the embodiments described in this specification. In an embodiment, the video coding device 400 may be a video decoder (for example, the decoder 30 in FIG. 1A) or a video encoder (for example, the encoder 20 in FIG. 1A). In another embodiment, the video coding device 400 may be one or more components in the decoder 30 in FIG. 1A or the encoder 20 in FIG. 1A.

The video coding device 400 includes an ingress port 410 and a receiving unit (Rx) 420 that are configured to receive data, a processor, logical unit, or central processing unit (CPU) 430 configured to process data, a transmitter unit (Tx) 440 and an egress port 450 that are configured to transmit data, and a memory 460 configured to store data. The video coding device 400 may further include an optical-to-electrical conversion component and an electro-optic (EO) component that are coupled to the ingress port 410, the receiver unit 420, the transmitter unit 440, and the egress port 450, configured to be used as an egress or an ingress of an optical signal or an electrical signal.

The processor 430 is implemented by using hardware and software. The processor 430 may be implemented as one or more CPU chips, cores (for example, a multi-core processor), FPGAs, ASICs, and DSPs. The processor 430 communicates with the ingress port 410, the receiver unit 420, the transmitter unit 440, the egress port 450, and the memory 460. The processor 430 includes a coding module 470 (for example, an encoding module 470 or a decoding module 470). The encoding/decoding module 470 implements the embodiments disclosed in this specification, to implement the weighted prediction method for multi-hypothesis encoding provided in the embodiments of the present disclosure. For example, the encoding/decoding module 470 implements, processes, or provides various encoding operations. Therefore, the encoding/decoding module 470 provides a substantial improvement to a function of the video coding device 400, and affects conversion of the video coding device 400 into different states. Alternatively, the encoding/decoding module 470 is implemented by using an instruction that is stored in the memory 460 and that is executed by the processor 430.

The memory 460 includes one or more disks, tape drives, and solid-state drives, and may be used as an overflow data storage device, configured to store programs when these programs are selectively executed, and store an instruction and data that are read in a program execution process. The memory 460 may be volatile and/or nonvolatile, and may be a read-only memory (ROM), a random access memory (RAM), a ternary content-addressable memory (TCAM), and/or a static random access memory (SRAM).

FIG. 5 is a simplified block diagram of an apparatus 500 that can be used as either or both of the source device 12 and the destination device 14 in FIG. 1A according to an example embodiment. The apparatus 500 may implement the technologies of the present disclosure. In other words, FIG. 5 is a schematic block diagram of an embodiment of an encoding device or a decoding device (referred to as a coding device 500) according to an embodiment of the present disclosure. The coding device 500 may include a processor 510, a memory 530, and a bus system 550. The processor is connected to the memory by using the bus system. The memory is configured to store an instruction, and the processor is configured to execute the instruction stored in the memory. The memory in the coding device stores program code, and the processor may invoke the program code stored in the memory, to perform various video encoding or decoding methods described in the present disclosure. To avoid repetition, details are not described herein again.

In this embodiment of this application, the processor 510 may be a central processing unit (“CPU” for short), or the processor 510 may be another general purpose processor, a digital signal processor (DSP), an application-specific integrated circuit (ASIC), a field-programmable gate array (FPGA) or another programmable logic device, a discrete gate or transistor logic device, a discrete hardware component, or the like. The general purpose processor may be a microprocessor, or the processor may be any conventional processor or the like.

The memory 530 may include a read-only memory (ROM) device or a random access memory (RAM) device. Any other suitable type of storage device may alternatively be used as the memory 530. The memory 530 may include code and data 531 accessed by the processor 510 by using the bus 550. The memory 530 may further include an operating system 533 and an application program 535. The application program 535 includes at least one program that allows the processor 510 to perform the video encoding or decoding method described in the present disclosure. For example, the application program 535 may include applications 1 to N, and further include a video encoding or decoding application (referred to as a video coding application) that performs the video encoding or decoding method described in the present disclosure.

The bus system 550 may further include a power bus, a control bus, a status signal bus, and the like in addition to a data bus. However, for clear description, various buses are marked as the bus system 550 in the figure.

In an embodiment, the coding device 500 may further include one or more output devices such as a display 570. In an instance, the display 570 may be a touch-sensitive display in which a display is combined with a touch-sensitive unit that operably senses touch input. The display 570 may be connected to the processor 510 by using the bus 550.

Although the processor 510 and the memory 530 in the apparatus 500 are depicted as being integrated into a single unit in FIG. 5, another configuration may be used. Running of the processor 510 may be distributed in a plurality of machines that can be directly coupled to each other (each machine has one or more processors), or distributed in a local area or another network. Memories 530 may be distributed in a plurality of machines, for example, network-based memories or memories in a plurality of machines running the apparatus 500. Although only a single bus is depicted herein, the bus 550 in the apparatus 500 may include a plurality of buses. Further, the memory 530 may be directly coupled to another component in the apparatus 500 or may be accessed by using a network, and may include a single integrated unit, for example, one storage card, or a plurality of units, for example, a plurality of memory cards. Therefore, the apparatus 500 may be implemented by using a plurality of configurations.

To better understand the technical solutions in the embodiments of the present disclosure, the following further describes the inter prediction mode, the intra prediction mode, and the multi-hypothesis encoding prediction mode in the embodiments of the present disclosure.

(1) Inter prediction mode. In inter prediction encoding, due to time-domain correlation of a same object in adjacent picture frames, each frame of a picture sequence may be divided into many non-overlapping blocks, and it may be considered that all picture elements in the block have a same motion. Main processing is determining motion information of a current block, obtaining a reference picture block from a reference picture based on the motion information, and generating a prediction picture of the current block. The motion information includes an inter prediction direction, a reference index (ref idx), a motion vector (MV), and the like. For inter prediction, the inter prediction direction is used to indicate which prediction direction in unidirectional prediction, bidirectional prediction, and multidirectional prediction is used for the current block, the reference index is used to indicate the reference picture, and the motion vector is used to indicate a location offset of the reference block of the current block in the reference picture relative to the current block in a current frame. The motion vector indicates a displacement vector of the reference picture block used to predict the current block in the reference picture relative to the current block. Therefore, one motion vector corresponds to one reference picture block.

The unidirectional prediction is determining a prediction block of a current block in a single direction based on a single-direction reference picture. Usually, the unidirectional prediction may also be correspondingly referred to as forward prediction or backward prediction based on a relative relationship between a picture order count of a reference picture frame and a picture order count of a current picture frame.

The bidirectional prediction includes first-direction prediction and second-direction prediction. The first-direction prediction is determining a prediction block of a current block in a first direction based on a first-direction reference picture. The first-direction reference picture is a reference picture in a first reference picture frame set, and the first reference picture frame set includes a quantity of reference pictures. The second-direction prediction is determining a prediction block of the current block in a second direction based on a second-direction reference picture. The second-direction reference picture is a reference picture in a second reference picture frame set, and the second reference picture frame set includes a quantity of reference pictures. A reconstructed block of the current block can be finally obtained provided that the first-direction prediction block and the second-direction prediction block are processed by using a preset algorithm (for example, weighted averaging). Usually, the bidirectional prediction may also be referred to as forward-backward prediction; in other words, the bidirectional prediction includes forward prediction and backward prediction. In this case, when the first-direction prediction is forward prediction, the second-direction prediction is correspondingly backward prediction; or when the first-direction prediction is backward prediction, the second-direction prediction is correspondingly forward prediction. For example, the first reference picture frame set is a reference picture list 0 , and the second reference picture frame set is a reference picture list 1. For another example, the first reference picture frame set is list1, and the second reference picture frame set is list0.

It may be understood that, in the multidirectional prediction, more reference picture frame sets are used than the bidirectional prediction. For example, reference picture frame sets for the multidirectional prediction include list0, list1, list2, . . .. In this case, a plurality of prediction blocks are determined based on reference pictures in different lists, and then the plurality of prediction blocks are processed based on a preset algorithm to obtain a reconstructed block of a current block.

In inter prediction encoding, commonly used inter prediction modes include an inter motion vector prediction (Inter MVP for short) mode and a merge mode. The inter MVP mode may further be an advanced motion vector prediction (AMVP) mode.

In the AMVP mode, an MV is first predicted for a current block. The predicted motion vector is also referred to as a motion vector prediction (MVP). The MVP may be directly obtained based on motion vectors of neighboring blocks around the current block in space domain, time-domain reference blocks corresponding to the current block, or time-domain reference blocks corresponding to neighboring blocks around the current block. Because there are a plurality of neighboring blocks, there are a plurality of MVPs. One MVP is essentially one candidate motion vector (candidate MV). In the AMVP mode, these MVPs are combined into an AMVP candidate list (AMVP candidate list). After establishing the AMVP candidate list, an encoder end selects an optimal MVP from the AMVP candidate list and determines a search startpoint in a reference picture based on the optimal MVP (the MVP is also a candidate MV); then, performs searching within a range near the search startpoint in a manner and calculates rate-distortion cost values; and finally obtains an optimal MV through calculation, where the optimal MV determines a location of an actual reference block (prediction block) in the reference picture, obtains a motion vector difference (MVD) by using a difference between the optimal MV and the optimal MVP, and encodes an index value corresponding to the optimal MVP in the AMVP candidate list and encodes an reference index. The encoder end sends the MVD, an index of the AMVP candidate list, the reference index, an inter prediction direction (forward, backward, bidirectional, multidirectional, or the like), and the like to a decoder end in a bitstream, to achieve video data compression. The decoder end obtains the MVD, the index value in the candidate list, the reference index, and the inter prediction direction through decoding from the bitstream. In addition, the decoder end establishes the AMVP candidate list, obtains the optimal MVP by using the index value, obtains the optimal MV based on the MVD and the optimal MVP, obtains the reference picture based on the inter prediction direction and the reference index, finds the prediction block from the reference picture by using the optimal MV, and finally obtains a reconstructed block of the current block by performing motion compensation on the prediction block.

In the merge mode, motion vectors of neighboring blocks around a current block in space domain, time-domain reference blocks corresponding to a current block, or time-domain reference blocks corresponding to neighboring blocks around a current block may also be used as candidate motion vectors (candidate MVs). Because there are a plurality of neighboring blocks, there are a plurality of candidate MVs. In the merge mode, a merge motion information candidate list (merge candidate list) is constructed based on these candidate MVs. In the merge mode, an MV of a neighboring block is directly used as a prediction motion vector of the current block; in other words, the current block shares one MV with the neighboring block (therefore, there is no MVD in this case), and a reference picture of the neighboring block is used as a reference picture of the current block. In the merge mode, all the candidate MVs in the merge motion information candidate list are traversed, rate-distortion cost values are calculated, and finally a candidate MV with a minimum rate-distortion cost value is selected as an optimal MV in the merge mode and an index value of the optimal MV in the merge motion information candidate list is encoded. An encoder end sends an index (a merge index) of the merge motion information candidate list to a decoder end in a bitstream, to achieve video data compression. The decoder end obtains the index of the merge motion information candidate list through decoding from the bitstream. In addition, the decoder end constructs the merge motion information candidate list, determines a candidate MV in the merge motion information candidate list as an optimal MV by using the index value, uses the reference picture of the neighboring block as the reference picture of the current block, finds a prediction block from the reference picture by using the optimal MV, and finally obtains a reconstructed block of the current block by performing motion compensation on the prediction block.

(2) Intra prediction mode. Intra prediction encoding is a prediction technology of predicting a pixel in a current block by using an encoded pixel in a current picture based on spatial correlation between intra pixels. In an instance, an intra prediction process is selecting an intra prediction mode from an intra prediction mode set (for example, an intra candidate list) to implement intra prediction. In another instance, some preset intra prediction modes (such as a planar mode) may be directly used to implement intra prediction.

In an embodiment, for a luma block (or referred to as a luma component) of a picture block, an intra candidate list may include four intra prediction modes: a planar mode, a vertical mode, a horizontal mode, and a DC mode. A size of the intra candidate list may be selected based on a shape of the current block, and may include three or four modes. When a width of the current block is twice greater than a height of the current block, the intra candidate list may not include the horizontal mode; or when a height of the current block is twice greater than a width of the current block, the intra candidate list may not include the vertical mode. For a chroma block (or referred to as a chroma component), a DM mode is used; in other words, a prediction mode that is the same as that used for the luma component is used.

In an embodiment, in a next-generation video encoding standard (such as H.266), an intra prediction mode of a chroma component of a picture further includes a linear model mode (LM mode for short).

In an embodiment, for a luma component of a picture, an intra candidate list may alternatively include 35 different intra prediction modes, including 33 direction prediction modes, a DC prediction mode, and a planar prediction mode. The direction prediction mode is mapping a reference pixel to a picture element location in a current block in a direction (marked by using an intra mode index) to obtain a prediction value of a current picture element; or for each picture element in a current block, inversely mapping a location of the picture element to a reference pixel in a direction (marked by using an intra mode index), where a pixel value of the corresponding reference pixel is a prediction value of the current pixel. Unlike the direction prediction mode, the DC prediction is using an average value of reference pixels as a prediction value of a pixel in a current block. The planar mode is jointly deriving a prediction value of a current picture element by using pixel values of reference picture elements directly above and directly to the left of the current picture element and pixel values of above-right and bottom-left reference picture elements of a current block.

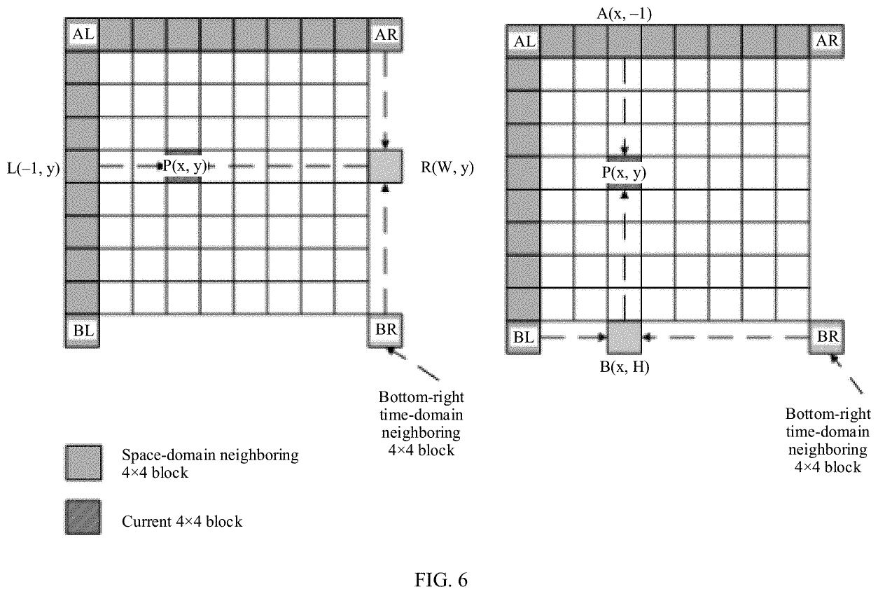

FIG. 6 shows an instantiated application scenario of a planar mode. As shown in FIG. 6, according to a planar method, motion information of an above space-domain neighboring location, a left space-domain neighboring location, a right location, and a bottom location of each sub-block (encoding subunit) of a current block is obtained, an average value of the motion information is obtained, and the average value is converted into motion information of each current sub-block.

For example, for a sub-block with coordinates (x, y), a sub-block motion vector P (x, y) may be obtained through calculation by using a horizontal-direction interpolation motion vector Pₕ (x, y) and a vertical-direction interpolation motion vector Pᵥ (x, y), as shown in formula (1):

P (x, y)=(H×Pₕ (x, y)+W×Pᵥ (x, y)+H×W)/(2×H×W) (1)

The horizontal-direction interpolation motion vector Pₕ (x, y) and the vertical-direction interpolation motion vector Pᵥ (x, y) may be obtained through calculation by using left, right, above, and bottom motion vectors of the current sub-block, as shown in formulas (2) and (3):

Pₕ (x, y)=(W−1−x)×L (−1, y)+(x+1)×R (W, y) (2)

Pᵥ (x, y)=(H−1−y)×A (x, −1)+(y+1)×B (x, H) (3)

L(−1, y) and R(W, y) represent motion vectors of left and right locations of the current sub-block, and A(x, −1) and B(x, H) represent motion vectors of above and bottom locations of the current sub-block.

The left motion vector L and the above motion vector A may be obtained from space-domain nearby blocks of the current encoding block. The motion vectors L(−1, y) and A(x, −1) of encoding blocks at preset locations (−1, y) and (x, −1) are obtained based on the sub-block coordinates (x, y).

The right motion vector R(W, y) and the bottom motion vector B(x, H) are extracted in the following method: extracting time-domain motion information BR at a bottom-right location of the current encoding block; performing weighting calculation by using an extracted motion vector AR at an upper-right space-domain nearby location and the extracted time-domain motion information BR at the bottom-right location, to obtain the right motion vector R(W, y), as shown in the following formula (4):

R(W, y)=((H−y−1)AR+(y+1)BR)/H (4); and

performing weighting calculation by using an extracted motion vector BL at a bottom-left space-domain nearby location and the extracted time-domain motion information BR at the bottom-right location, to obtain the bottom motion vector B(x, H), as shown in the following formula (5):

B(x, H)=((W−x−1)BL+(x+1)BR)/W (5)

All the motion vectors used in the foregoing calculation are scaled to point to the first reference picture in a reference picture queue.

(3) Multi-hypothesis encoding prediction mode. The multi-hypothesis encoding prediction mode is using a plurality of prediction modes in prediction of a current block. In an embodiment, joint intra prediction encoding and inter prediction encoding may be implemented by using the multi-hypothesis encoding prediction mode; in other words, both an inter prediction mode and an intra prediction mode are used in the prediction of the current block.

In an embodiment of an existing multi-hypothesis encoding scheme with joint intra prediction encoding and inter prediction encoding, a flag (for example, mh_intra_flag) is transmitted in an encoding block/CU to be encoded by using a merge mode, where the flag is used to indicate whether intra prediction encoding is to be used; when it is determined that intra prediction encoding can be used, an intra prediction block is obtained by using an intra prediction mode, and an inter prediction block is obtained based on a merge index of the merge mode; and then equal-ratio weighting (namely, average weighting) is performed on the intra prediction block and the inter prediction block to generate a final prediction block. However, such a weighting manner is too simple and causes relatively low prediction accuracy of a pixel value of a picture and relatively low encoding/decoding performance, and therefore is difficult to be applied to a complex encoding/decoding scenario.

To resolve the foregoing technical defects, the embodiments of the present disclosure provide some adaptive weighting schemes, to improve prediction accuracy of a pixel value of a picture in a multi-hypothesis encoding scenario and encoding/decoding performance. The weighting schemes are mainly described in this specification by using an example in which the multi-hypothesis encoding scenario is joint intra prediction encoding and inter prediction encoding.

In the embodiments of the present disclosure, an encoder end may implicitly or explicitly indicate weight coefficients respectively corresponding to an inter prediction mode and an intra prediction mode to a decoder end by using indication information. A weight coefficient corresponding to the inter prediction mode is used to indicate a weight of a pixel value of a first target prediction block obtained by predicting a current block by using the inter prediction mode in weighted prediction for multi-hypothesis encoding, and a weight coefficient corresponding to the intra prediction mode is used to indicate a weight of a pixel value of a second target prediction block obtained by predicting the current block by using the intra prediction mode in the weighted prediction for multi-hypothesis encoding. In the embodiments of the present disclosure, the indication information corresponds to different weight coefficient combinations in different cases, and the weight coefficient combination includes the weight coefficients respectively corresponding to the inter prediction mode and the intra prediction mode.

For ease of description, the weight coefficient corresponding to the inter prediction mode may be denoted as M, and the weight coefficient corresponding to the intra prediction mode may be denoted as N, where M and N are integers. M and N may have different values, a plurality of weight coefficient combinations {Mi, Ni} are preset on the encoder end and the decoder end based on different values of M and N, where Mi and Ni are integers. Based on different actual encoding/decoding scenarios, the encoder end and the decoder end may adaptively select most appropriate weight coefficient combinations to implement weighted prediction for multi-hypothesis encoding.

In this case, subsequently, after determining the weight coefficient combination {Mi, Ni} corresponding to the weighted prediction of the current block, the decoder end/coder end may weight the pixel value of the first target prediction block and the pixel value of the second target prediction block by using the weight coefficient combination {Mi, Ni}, to obtain a prediction value of the current block.

For example, a prediction pixel value of a location point in the current block is denoted as Samples[x][y], x and y are a horizontal coordinate and a vertical coordinate of the pixel value respectively, and Samples[x][y] may be obtained through calculation by using the following formula (6):

Samples[x][y]=Clip3(0, ((1<<bitDepth)−1), ((predSamplesIntra[x][y]*Ni+predSamplesInter[x][y]*Mi+offset)>>shift)) (6)

Clip3(.) is a clip function, bitDepth is a bit depth of Samples data, predSamplesIntra[x][y] represents an intra prediction pixel value of a [x][y] location, predSamplesInter[x][y] represents an inter prediction pixel value of the [x][y] location, and offset represents value precision. In an embodiment, a value of shift may be determined in a manner in which a sum of Mi and Ni is equal to 2 raised to the power of shift, to omit an unnecessary division operation.

The following describes in detail some embodiments of adaptively determining, based on different encoding/decoding scenarios, the weight coefficient combination {Mi, Ni} corresponding to the weighted prediction of the current block in the embodiments of the present disclosure. These embodiments may be applied to the encoder end and/or the decoder end.

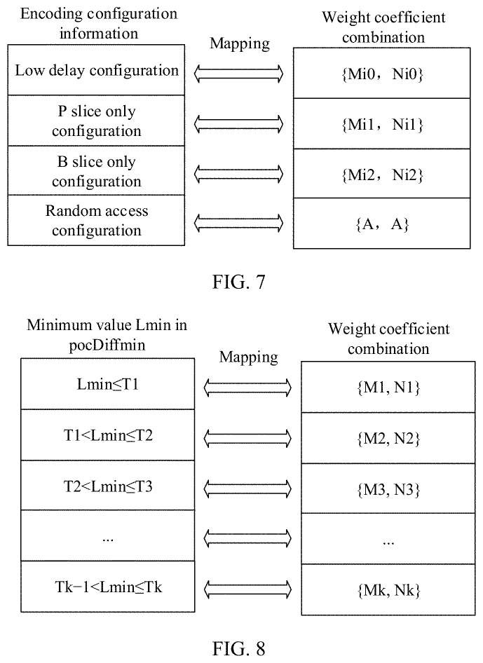

In an embodiment, referring to FIG. 7, a mapping relationship between encoding configuration information and a weight coefficient combination {Mi, Ni} may be established. The encoding configuration information is, for example, a low delay (Low delay) configuration, a P slice only (P slice only) configuration, a B slice only (B slice only) configuration, or a random access (random access) configuration. As shown in FIG. 7, for the low delay configuration, the P slice only configuration, and the B slice only configuration, it may be set that unequal-ratio weighting is used for the intra prediction block and the inter prediction block, and the weight coefficient M corresponding to the inter prediction mode is greater than the weight coefficient N corresponding to the intra prediction mode. For example, a weight coefficient combination to which the low delay configuration is mapped is set to {Mi0, Ni0}, and Mi0>Ni0; a weight coefficient combination to which the P slice only configuration is mapped is set to {Mi1, Ni1}, and Mi1>Ni1; a weight coefficient combination to which the B slice only configuration is mapped is set to {Mi2, Ni2}, and Mi2>Ni2; and for a random access configuration, it may be set that equal-ratio weighting is used for the intra prediction block and the inter prediction block, and as shown in the figure, a weight coefficient combination to which the random access configuration is mapped is set to {A, A}.

In the foregoing solution, the decoder end may parse a bitstream to obtain the indication information of an encoding configuration of a current to-be-decoded picture. For example, the indication information is a slice-level or frame-level reference picture queue construction information transmitted by the encoder end to the decoder end by using the bitstream. The decoder end constructs a reference picture queue based on the information. The reference picture queue includes one or more reference picture lists, for example, list0, list1, list2, . . . . If finding, based on picture order counts (POC), that reference pictures in all the reference picture lists in the reference picture queue are all located before the current to-be-decoded picture in time domain, the decoder end determines that a current encoding configuration is the low delay (Low delay) configuration. In this case, in multi-hypothesis encoding with joint intra prediction encoding and inter prediction encoding, the weight coefficient corresponding to the inter prediction mode is Mi0, and the weight coefficient corresponding to the intra prediction mode is Ni0.

In an embodiment, the weight coefficients respectively corresponding to the inter prediction mode and the intra prediction mode may be set based on time-domain distances between reference pictures closest to a current picture in different reference picture lists in a reference picture queue and the current picture (the time-domain distance may be referred to as a closest time-domain distance). The reference picture queue includes one or more reference picture lists, for example, may be list0, list1, . . . , and listN, where N is an integer greater than or equal to 0. Each reference picture list includes one or more frames of reference pictures, a time-domain distance between a reference picture in the reference picture list and the current picture may be denoted as pocDiff, and pocDiff may be obtained through calculation based on an absolute value of a difference between a POC of the reference picture and a POC of the current picture. A time-domain distance between a reference picture closest to the current picture in the reference picture list and the current picture is a closest time-domain distance. In other words, a time-domain distance between each reference picture in any reference picture list and the to-be-processed picture block may be determined, and a minimum time-domain distance value is determined as a closest time-domain distance of the any reference picture set. The closest time-domain distance of the reference picture list may be denoted as pocDiffmin; in other words, pocDiffmin is a minimum value in pocDiff corresponding to all reference pictures in the reference picture list. For the reference picture queue, pocDiffmin corresponding to different reference picture lists may be respectively denoted as pocDiffmin0, pocDiffmin1, . . . , and pocDiffminN.

In an embodiment, a minimum value in pocDiffmin0, pocDiffmin1, . . . , and pocDiffminN is denoted as Lmin. In this case, a mapping relationship between Lmin and a weight coefficient combination {Mi, Ni} may be established. As shown in FIG. 8, when Lmin≤T1, the weight coefficient combination corresponding to the inter prediction mode and the intra prediction mode is {M1, Ni}; when T1<Lmin≤T2, the weight coefficient combination corresponding to the inter prediction mode and the intra prediction mode is {M2, N2}; when T2<Lmin≤T3, the weight coefficient combination corresponding to the inter prediction mode and the intra prediction mode is {M3, N3}; and so on. By analogy, when Tk−1<Lmin≤Tk, the weight coefficient combination corresponding to the inter prediction mode and the intra prediction mode is {Mk, Nk}. M1, M2, M3, . . . , and Mk, N1, N2, N3, . . . , and Nk, and T1, T2, T3, . . . , and Tk are positive integers, and T1<T2<T3.

In a possible application scenario, M1/N1≤M2/N2, M2/N2≤M3/N3, . . . , and Mk−1/Nk−1≤Mk/Nk, and M1/N1≠Mk/Nk may be set.

In another possible application scenario, floating point number (M1/N1)<floating point number (M2/N2), floating point number (M2/N2)≤floating point number (M3/N3), . . . , and floating point number (Mk−1/Nk−1)≤floating point number (Mk/Nk), and floating point number (M1/N1) floating point number (Mk/Nk) may be set.

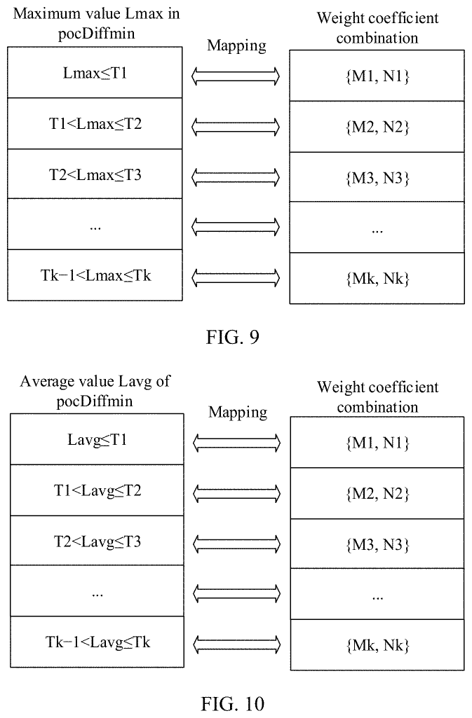

In an embodiment, a maximum value in pocDiffmin0, pocDiffmin1, . . . , and pocDiffminN is denoted as Lmax. In this case, a mapping relationship between Lmax and a weight coefficient combination {Mi, Ni} may be established. As shown in FIG. 9, when Lmax≤T1, the weight coefficient combination corresponding to the inter prediction mode and the intra prediction mode is {M1, N1}; when T1<Lmax≤T2, the weight coefficient combination corresponding to the inter prediction mode and the intra prediction mode is {M2, N2}; when T2<Lmax≤T3, the weight coefficient combination corresponding to the inter prediction mode and the intra prediction mode is {M3, N3}; and so on. By analogy, when Tk−1<Lmax≤Tk, the weight coefficient combination corresponding to the inter prediction mode and the intra prediction mode is {Mk, Nk}. M1, M2, M3, . . . , and Mk, N1, N2, N3, . . . , and Nk, and T1, T2, T3, . . . , and Tk are positive integers, and Tl<T2<T3.

In a possible application scenario, M1/N1≤M2/N2, M2/N2≤M3/N3, . . . , and Mk−1/Nk−1≤Mk/Nk, and M1/N1≠Mk/Nk may be set.

In another possible application scenario, floating point number (M1/N1)≤floating point number (M2/N2), floating point number (M2/N2)≤floating point number (M3/N3), . . . , and floating point number (Mk−1/Nk−1)≤floating point number (Mk/Nk), and floating point number (M1/N1)≠floating point number (Mk/Nk) may be set.

In an embodiment, an average value of pocDiffmin0, pocDiffmin1, . . . , and pocDiffminN is denoted as Lavg. In this case, a mapping relationship between Lavg and a weight coefficient combination {Mi, Ni} may be established. As shown in FIG. 10, when Lavg≤T1, the weight coefficient combination corresponding to the inter prediction mode and the intra prediction mode is {M1, Ni}; when T1<Lavg≤T2, the weight coefficient combination corresponding to the inter prediction mode and the intra prediction mode is {M2, N2}; when T2<Lavg≤T3, the weight coefficient combination corresponding to the inter prediction mode and the intra prediction mode is {M3, N3}; and so on. By analogy, when Tk−1<Lavg≤Tk, the weight coefficient combination corresponding to the inter prediction mode and the intra prediction mode is {Mk, Nk}. M1, M2, M3, . . . , and Mk, N1, N2, N3, . . . , and Nk, and T1, T2, T3, . . . , and Tk are positive integers, and Tl<T2<T3.

In a possible application scenario, M1/N1≤M2/N2, M2/N2≤M3/N3, . . . , and Mk−1/Nk−1≤Mk/Nk, and M1/N1≠Mk/Nk may be set.

In another possible application scenario, floating point number (M1/N1)≤floating point number (M2/N2), floating point number (M2/N2)≤floating point number (M3/N3), . . . , and floating point number (Mk−1/Nk−1)≤floating point number (Mk/Nk), and floating point number (M1/N1)≠floating point number (Mk/Nk) may be set.

In the foregoing solution, the decoder end may parse a bitstream to obtain indication information of a closest time-domain distance of the reference picture queue. For example, the indication information is slice-level or frame-level reference picture queue construction information transmitted by the encoder end to the decoder end by using the bitstream. The decoder end constructs the reference picture queue based on the information. The reference picture queue includes one or more reference picture lists, for example, list0, list1, . . . , and listN. In this case, the decoder end may obtain pocDiffmin0, pocDiffmin1, . . . , and pocDiffminN based on POCs of all reference pictures in all the reference picture lists and the POC of the current picture, and then obtain the minimum value Lmin, the maximum value Lmax, or the average value Lavg in the closest time-domain distances; and then obtain, based on the mapping relationship between a minimum value Lmin, a maximum value Lmax, or an average value Lavg and a weight coefficient combination {Mi, Ni}, the weight coefficients respectively corresponding to the inter prediction mode and the intra prediction mode.

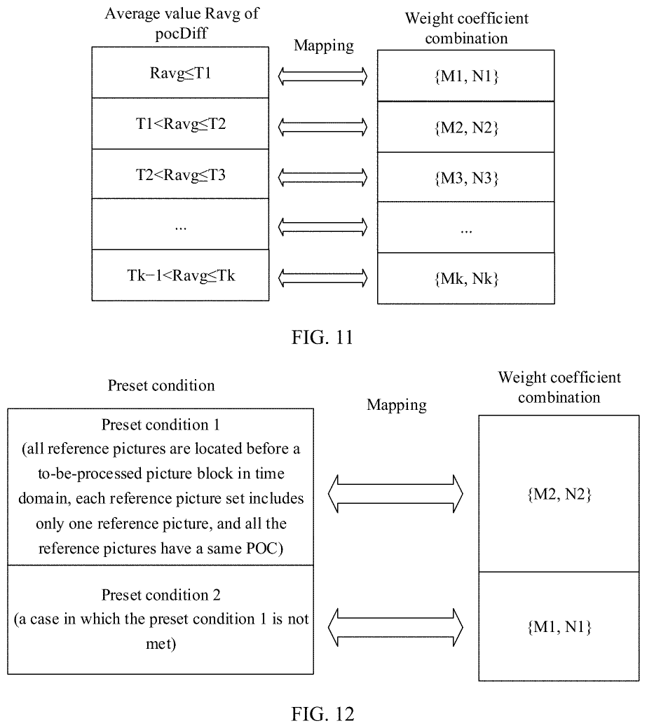

In an embodiment, an average value of pocDiff of all reference pictures in a preset reference picture list (for example, list0) in the reference picture queue may be denoted as Ravg. In this case, a mapping relationship between Ravg and a weight coefficient combination {Mi, Ni} may be established. As shown in FIG. 11, when Ravg≤T1, the weight coefficient combination corresponding to the inter prediction mode and the intra prediction mode is {M1, N1}; when T1<Ravg≤T2, the weight coefficient combination corresponding to the inter prediction mode and the intra prediction mode is {M2, N2}; when T2<Ravg≤T3, the weight coefficient combination corresponding to the inter prediction mode and the intra prediction mode is {M3, N3}; and so on. By analogy, when Tk−1<Ravg≤Tk, the weight coefficient combination corresponding to the inter prediction mode and the intra prediction mode is {Mk, Nk}. M1, M2, M3, . . . , and Mk, N1, N2, N3, . . . , and Nk, and T1, T2, T3, . . . , and Tk are positive integers, and T1<T2<T3.

In a possible application scenario, M1/N1≤M2/N2, M2/N2≤M3/N3, . . . , and Mk−1/Nk−1≤Mk/Nk, and M1/N1≠Mk/Nk may be set.

In another possible application scenario, floating point number (M1/N1)≤floating point number (M2/N2), floating point number (M2/N2)≤floating point number (M3/N3), . . . , and floating point number (Mk−1/Nk−1)≤floating point number (Mk/Nk), and floating point number (M1/N1) floating point number (Mk/Nk) may be set.

In the foregoing solution, the decoder end may parse a bitstream to obtain indication information of a closest time-domain distance of the reference picture queue. For example, the indication information is slice-level or frame-level reference picture queue construction information transmitted by the encoder end to the decoder end by using the bitstream. The decoder end constructs the reference picture queue based on the information. The reference picture queue includes one or more reference picture lists, for example, list0, list1, . . . , and listN, and determines the preset reference picture list (for example, list0) from the reference picture queue. In this case, the decoder end may obtain pocDiff of all the reference pictures based on POCs of all the reference pictures in the preset reference picture list (for example, list0) and the POC of the current picture, and calculate the average value of pocDiff of all the reference pictures as Ravg; and then obtain, based on the mapping relationship between Ravg and a weight coefficient combination {Mi, Ni}, the weight coefficients respectively corresponding to the inter prediction mode and the intra prediction mode.

In an embodiment, the weight coefficients respectively corresponding to the inter prediction mode and the intra prediction mode may be set based on features such as quantities of reference pictures in different reference picture lists in a reference picture queue. The reference picture queue includes one or more reference picture lists, for example, may be list0, list1, . . . , and listN, where N is an integer greater than or equal to 0. Each reference picture list includes one or more frames of reference pictures.

In an embodiment, a preset condition 1 may be set to as follows: When reference pictures in all reference picture lists in all reference picture queues are all located before a current picture in time domain, quantities of reference pictures in list0, list1, . . . , and listN are all 1, and reference pictures in list0, list1, . . . , and listN are reference pictures of a same frame (in other words, with a same POC); and a preset condition 2 may be set to a case in which the preset condition 1 is not met. In this case, a mapping relationship between a preset condition and a weight coefficient combination {Mi, Ni} may be established. As shown in FIG. 12, if a current encoding/decoding status meets the preset condition 1, the weight coefficient combination corresponding to the inter prediction mode and the intra prediction mode is {M2, N2}; or if a current encoding/decoding status does not meet the preset condition 1 (in other words, the preset condition 2 is met in this case), the weight coefficient combination corresponding to the inter prediction mode and the intra prediction mode is {M1, N1}. M1, M2, N1, and N2 are positive integers. In a possible application scenario, M1>N1 and M2>N2 may be further set.

In a possible application scenario, M1/N1≤M2/N2 may be set.

In another possible application scenario, floating point number (M1/N1)≤floating point number (M2/N2) may be set.

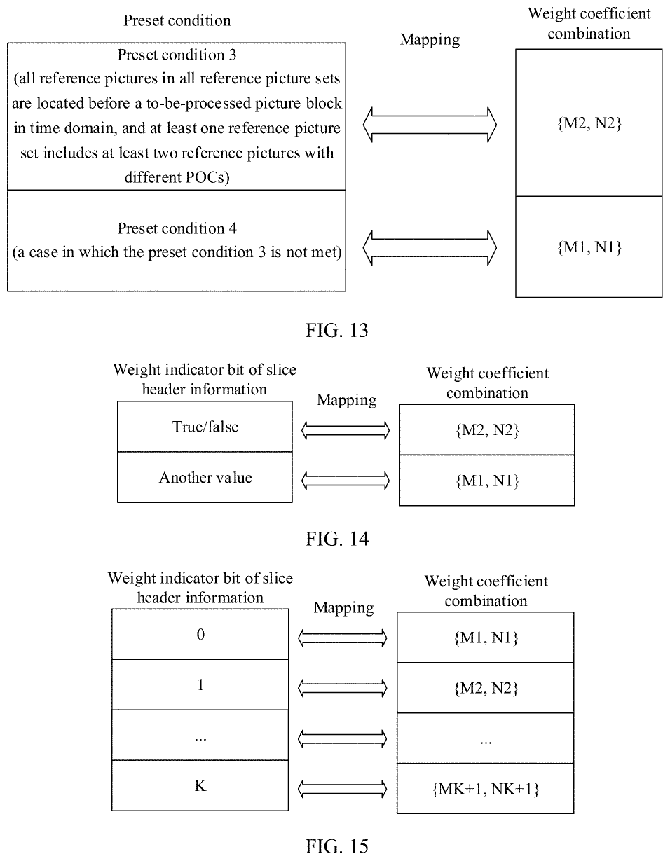

In an embodiment, a preset condition 3 may be set to as follows: When reference pictures in all reference picture lists in all reference picture queues are all located before a current picture in time domain, a quantity of reference pictures with different POCs in list0, list1, . . . , and listN is greater than or equal to 2; and a preset condition 4 may be set to a case in which the preset condition 3 is not met. In this case, a mapping relationship between a preset condition and a weight coefficient combination {Mi, Ni} may be established. As shown in FIG. 13, if a current encoding/decoding status meets the preset condition 3, the weight coefficient combination corresponding to the inter prediction mode and the intra prediction mode is {M2, N2}; or if a current encoding/decoding status does not meet the preset condition 3 (in other words, the preset condition 4 is met in this case), the weight coefficient combination corresponding to the inter prediction mode and the intra prediction mode is {M1, N1}. M1, M2, N1, and N2 are positive integers. In a possible application scenario, M1>N1 and M2>N2 may be further set.

In a possible application scenario, M1/N1≤M2/N2 may be set.

In another possible application scenario, floating point number (M1/N1)≤floating point number (M2/N2) may be set.

In the foregoing solution, the decoder end may parse a bitstream to obtain indication information of a closest time-domain distance of the reference picture queue. For example, the indication information is slice-level or frame-level reference picture queue construction information transmitted by the encoder end to the decoder end by using the bitstream. The decoder end constructs the reference picture queue based on the information. The reference picture queue includes the one or more reference picture lists, for example, list0, list1, . . . , and listN, and each reference picture list includes one or more frames of reference pictures. The decoder end may determine, based on quantities of reference pictures in different reference picture lists, a preset condition met by a current encoding/decoding status, and obtain, based on the mapping relationship between a preset condition and a weight coefficient combination {Mi, Ni}, the weight coefficients respectively corresponding to the inter prediction mode and the intra prediction mode.

It may be understood that, in an embodiment described above, the encoder end mainly implicitly indicates the weight coefficients respectively corresponding to the inter prediction mode and the intra prediction mode to the decoder end. In an embodiment, the encoder end may directly explicitly indicate the weight coefficients respectively corresponding to the inter prediction mode and the intra prediction mode to the decoder end.

In an embodiment, the indication information transmitted by the encoder end to the decoder end by using a bitstream includes a weight indicator bit of slice header (slice header) information in a syntax element, and the weight indicator bit of the slice header information may be directly used to indicate the weight coefficient combination; in other words, there are mapping relationships between different values of the weight indicator bit and weight coefficient combinations {Mi, Ni}.

In an embodiment, as shown in FIG. 14, when the weight indicator bit of the slice header information in the bitstream is true/false (True/false) (in other words, when the weight indicator bit is a first indication value), the weight coefficient combination corresponding to the inter prediction mode and the intra prediction mode is {M2, N2}; or when the weight indicator bit of the slice header information is another value (in other words, when the weight indicator bit is a second indication value), the weight coefficient combination corresponding to the inter prediction mode and the intra prediction mode is {M1, N1}. M1, M2, N1, and N2 are positive integers, and M1/N1≤M2/N2. In a possible application scenario, floating point number (M1/N1)≤floating point number (M2/N2) may be set. In a possible application scenario, M1>N1 and M2>N2 may be further set.

In an embodiment, as shown in FIG. 15, when the weight indicator bit of the slice header information in the bitstream is 0 (in other words, when the weight indicator bit is a first indication value), the weight coefficient combination corresponding to the inter prediction mode and the intra prediction mode is {M1, N1}; or when the weight indicator bit of the slice header information in the bitstream is 1 (in other words, when the weight indicator bit is a second indication value), the weight coefficient combination corresponding to the inter prediction mode and the intra prediction mode is {M2, N2}. By analogy, when the weight indicator bit of the slice header information in the bitstream is k, the weight coefficient combination corresponding to the inter prediction mode and the intra prediction mode is {Mk+1, Nk+1}. M1, M2, . . . , and Mk+1, and N1, N2, . . . , and Nk+1 are positive integers. In a possible application scenario, M1>N1 and M2>N2 may be further set.

In a possible application scenario, M1/N1≤M2/N2, . . . , and Mk/Nk≤Mk+1/Nk+1, and M1/N1≠Mk/Nk may be set.

In a possible application scenario, floating point number (M1/N1)≤floating point number (M2/N2), . . . , and floating point number (Mk/Nk)≤floating point number (Mk+1/Nk+1), and floating point number (M1/N1)≠floating point number (Mk+1/Nk+1) may be set.

In a possible application scenario, floating point number (M1/N1)≥floating point number (M2/N2), . . . , and floating point number (Mk/Nk)≥floating point number (Mk+1/Nk+1), and floating point number (M1/N1)≠floating point number (Mk+1/Nk+1) may be set.

In an embodiment, when the weight indicator bit of the slice header information is a first indication value, the weight coefficient corresponding to the inter prediction mode and the weight coefficient corresponding to the intra prediction mode are respectively determined from a first set and a second set based on the first indication value. Correspondingly, when the weight indicator bit of the slice header information is a second indication value, the weight coefficient corresponding to the inter prediction mode and the weight coefficient corresponding to the intra prediction mode are respectively determined from a first set and a second set based on the second indication value.

The first set may include two or more optional values, for example, may be <M1, M2, M3, . . . >. Therefore, a value may be selected from the first set based on the first indication value. For example, M1 is selected from the first set based on the first indication value as the weight coefficient corresponding to the inter prediction mode. The second set may include two or more optional values, for example, may be <N1, N2, N3, . . . >. Therefore, a value may be selected from the second set based on the first indication value. For example, N1 is selected from the second set based on the first indication value as the weight coefficient corresponding to the intra prediction mode.

Likewise, a value may be selected from the first set based on the second indication value. For example, M2 is selected from the first set based on the second indication value as the weight coefficient corresponding to the inter prediction mode. A value may be selected from the second set based on the second indication value. For example, N2 is selected from the second set based on the second indication value as the weight coefficient corresponding to the intra prediction mode.

A ratio of the weight coefficient that is of the inter prediction mode and that is determined based on the first indication value to the weight coefficient that is of the intra prediction mode and that is determined based on the first indication value is less than or equal to a ratio of the weight coefficient that is of the inter prediction mode and that is determined based on the second indication value to the weight coefficient that is of the intra prediction mode and that is determined based on the second indication value. For example, M1, M2, N1, and N2 are positive integers, and M1/N1≤M2/N2.

The following describes a manner of setting the first set and the second set. In a possible manner, when the plurality of reference picture sets include reference pictures with different POCs and all reference pictures in all the reference picture sets are located before the to-be-processed picture block in time domain, it may be set that the first set includes at least M1 and M2, and it may be set that the second set includes at least Ni and N2; or in a case other than the case, it may be set that the first set includes at least M3 and M4, and it may be set that the second set includes at least N3 and N4.

M1/N1≤M3/N3, M2/N2≤M4/N4, and M1, M2, M3, M4, Ni, N2, N3, and N4 are positive integers.

In the foregoing solution, the decoder end may parse the bitstream to obtain the weight indicator bit of the slice header information, and obtain, based on the mapping relationships between different values of the weight indicator bit of the slice header information and weight coefficient combinations {Mi, Ni}, the weight coefficients respectively corresponding to the inter prediction mode and the intra prediction mode.

In an embodiment, the indication information transmitted by the encoder end to the decoder end by using a bitstream includes a weight indicator bit of largest coding unit (LCU) information in a syntax element, and the weight indicator bit of the LCU information may also be used to determine the weight coefficient combination. The decoder end may determine, based on the weight indicator bit of the LCU information, the weight coefficients respectively corresponding to the inter prediction mode and the intra prediction mode.

In an embodiment, when the weight indicator bit of the LCU information is a third indication value, the weight coefficient combination may be set to {M1, N1}, where the inter prediction mode and the intra prediction mode respectively correspond to M1 and N1; or when the weight indicator bit of the LCU information is a fourth indication value, the weight coefficients respectively corresponding to the inter prediction mode and the intra prediction mode are set to M2 and N2 respectively. M1/N1≤M2/N2, and M1, M2, N1, and N2 are positive integers.

In an embodiment, when the weight indicator bit of the LCU information is a third indication value, the weight coefficient corresponding to the inter prediction mode and the weight coefficient corresponding to the intra prediction mode are respectively determined from a third set and a fourth set based on the third indication value; or when the weight indicator bit of the LCU information is a fourth indication value, the weight coefficient corresponding to the inter prediction mode and the weight coefficient corresponding to the intra prediction mode are respectively determined from a third set and a fourth set based on the fourth indication value.

The third set may include two or more optional values, for example, may be <M1, M2, M3, . . . >. Therefore, a value may be selected from the third set based on the third indication value. For example, M1 is selected from the third set based on the third indication value as the weight coefficient corresponding to the inter prediction mode. The fourth set may include two or more optional values, for example, may be <N1, N2, N3, . . . >. Therefore, a value may be selected from the fourth set based on the third indication value. For example, Ni is selected from the fourth set based on the third indication value as the weight coefficient corresponding to the intra prediction mode.

Likewise, a value may be selected from the third set based on the fourth indication value. For example, M2 is selected from the third set based on the fourth indication value as the weight coefficient corresponding to the inter prediction mode. A value may be selected from the fourth set based on the fourth indication value. For example, N2 is selected from the fourth set based on the fourth indication value as the weight coefficient corresponding to the intra prediction mode.

A ratio of the weight coefficient that is of the inter prediction mode and that is determined based on the third indication value to the weight coefficient that is of the intra prediction mode and that is determined based on the third indication value is less than a ratio of the weight coefficient that is of the inter prediction mode and that is determined based on the fourth indication value to the weight coefficient that is of the intra prediction mode and that is determined based on the fourth indication value.

The following describes some manners of setting the third set and the fourth set.

In a possible manner, when the plurality of reference picture sets include reference pictures with different POCs and all reference pictures in all the reference picture sets are located before the to-be-processed picture block in time domain, it may be set that the third set includes at least M1 and M2, and it may be set that the fourth set includes at least N1 and N2; or in a case other than the case, it may be set that the third set includes at least M3 and M4, and it may be set that the fourth set includes at least N3 and N4.

M1/N1≤M3/N3, M2/N2≤M4/N4, and M1, M2, M3, M4, Ni, N2, N3, and N4 are positive integers.

In another possible manner, the indication information in the bitstream includes both the weight indicator bit of the LCU information and a weight indicator bit of slice header information. In this case, when the weight indicator bit of the slice header information is a first indication value, it may be set that the third set includes at least M1 and M2, and it may be set that the fourth set includes at least N1 and N2; or when the weight indicator bit of the slice header information is a second indication value, it may be set that the third set includes at least M3 and M4, and it may be set that the fourth set includes at least N3 and N4.

M1/N1≤M3/N3, M2/N2≤M4/N4, and M1, M2, M3, M4, N1, N2, N3, and N4 are positive integers.

It should be noted that, for a detailed implementation process of determining, based on the weight indicator bit of the LCU information, the weight coefficients respectively corresponding to the inter prediction mode and the intra prediction mode, similarly refer to the implementation of the weight indicator bit of the slice header information. For brevity of the specification, details are not described herein.

In the foregoing solution, the decoder end may parse the bitstream to obtain the weight indicator bit of the LCU information, and obtain, based on mapping relationships between different values of the weight indicator bit of the LCU information and weight coefficient combinations {Mi, Ni}, the weight coefficients respectively corresponding to the inter prediction mode and the intra prediction mode. In an embodiment, the decoder end may further parse out the weight indicator bit of the slice header information, and obtain, based on the weight indicator bit of the LCU information and the weight indicator bit of the slice header information, the weight coefficients respectively corresponding to the inter prediction mode and the intra prediction mode.

In an embodiment, the indication information transmitted by the encoder end to the decoder end by using a bitstream includes a weight indicator bit of coding unit (CU) information in a syntax element, and the weight indicator bit of the CU information may also be used to determine the weight coefficient combination. The decoder end may determine, based on the weight indicator bit of the CU information, the weight coefficients respectively corresponding to the inter prediction mode and the intra prediction mode.

In an embodiment, when the weight indicator bit of the CU information is a fifth indication value, the weight coefficient may be set to {M1, N1}, where the inter prediction mode and the intra prediction mode respectively correspond to M1 and N1; or when the weight indicator bit of the CU information is a sixth indication value, the weight coefficients respectively corresponding to the inter prediction mode and the intra prediction mode are set to M2 and N2 respectively. M1/N1≤M2/N2, and M1, M2, N1, and N2 are positive integers.

In an embodiment, when the weight indicator bit of the CU information is a fifth indication value, the weight coefficient corresponding to the inter prediction mode and the weight coefficient corresponding to the intra prediction mode are respectively determined from a fifth set and a sixth set based on the fifth indication value; or when the weight indicator bit of the CU information is a sixth indication value, the weight coefficient corresponding to the inter prediction mode and the weight coefficient corresponding to the intra prediction mode are respectively determined from a fifth set and a sixth set based on the sixth indication value.

The fifth set may include two or more optional values, for example, may be <M1, M2, M3, . . . >. Therefore, a value may be selected from the fifth set based on the fifth indication value. For example, M1 is selected from the fifth set based on the fifth indication value as the weight coefficient corresponding to the inter prediction mode. The sixth set may include two or more optional values, for example, may be <N1, N2, N3, . . . >. Therefore, a value may be selected from the sixth set based on the fifth indication value. For example, Ni is selected from the sixth set based on the fifth indication value as the weight coefficient corresponding to the intra prediction mode.

Likewise, a value may be selected from the fifth set based on the sixth indication value. For example, M2 is selected from the fifth set based on the sixth indication value as the weight coefficient corresponding to the inter prediction mode. A value may be selected from the sixth set based on the six indication value. For example, N2 is selected from the sixth set based on the sixth indication value as the weight coefficient corresponding to the intra prediction mode.

A ratio of the weight coefficient that is of the inter prediction mode and that is determined based on the fifth indication value to the weight coefficient that is of the intra prediction mode and that is determined based on the fifth indication value is less than a ratio of the weight coefficient that is of the inter prediction mode and that is determined based on the sixth indication value to the weight coefficient that is of the intra prediction mode and that is determined based on the sixth indication value.

The following describes some manners of setting the fifth set and the sixth set. In possible manner, the indication information in the bitstream includes both the weight indicator bit of the CU information and a weight indicator bit of slice header information. In this case, when the weight indicator bit of the slice header information is a first indication value, it may be set that the fifth set includes at least M1 and M2, and it may be set that the sixth set includes at least N1 and N2; or when the weight indicator bit of the slice header information is a second indication value, it may be set that the fifth set includes at least M3 and M4, and it may be set that the sixth set includes at least N3 and N4.

M1/N1≤M3/N3, M2/N2≤M4/N4, and M1, M2, M3, M4, Ni, N2, N3, and N4 are positive integers.

It should be noted that, for a detailed implementation process of determining, based on the weight indicator bit of the CU information, the weight coefficients respectively corresponding to the inter prediction mode and the intra prediction mode, similarly refer to the implementation of the weight indicator bit of the slice header information. For brevity of the specification, details are not described herein.

In the foregoing solution, the decoder end may parse the bitstream to obtain the weight indicator bit of the CU information, and obtain, based on mapping relationships between different values of the weight indicator bit of the CU information and weight coefficient combinations {Mi, Ni}, the weight coefficients respectively corresponding to the inter prediction mode and the intra prediction mode. In an embodiment, the decoder end may further parse out the weight indicator bit of the slice header information, and obtain, based on the weight indicator bit of the CU information and the weight indicator bit of the slice header information, the weight coefficients respectively corresponding to the inter prediction mode and the intra prediction mode.

It may be learned that, the various solutions in the embodiments of the present disclosure are implemented, so that the weight coefficients respectively corresponding to the inter prediction mode and the intra prediction mode can be adaptively determined based on different encoding/decoding scenarios, thereby ensuring normal execution of multi-hypothesis encoding in diversified scenarios, and improving picture prediction accuracy and encoding performance compared with an equal-ratio weighting manner in the prior art.

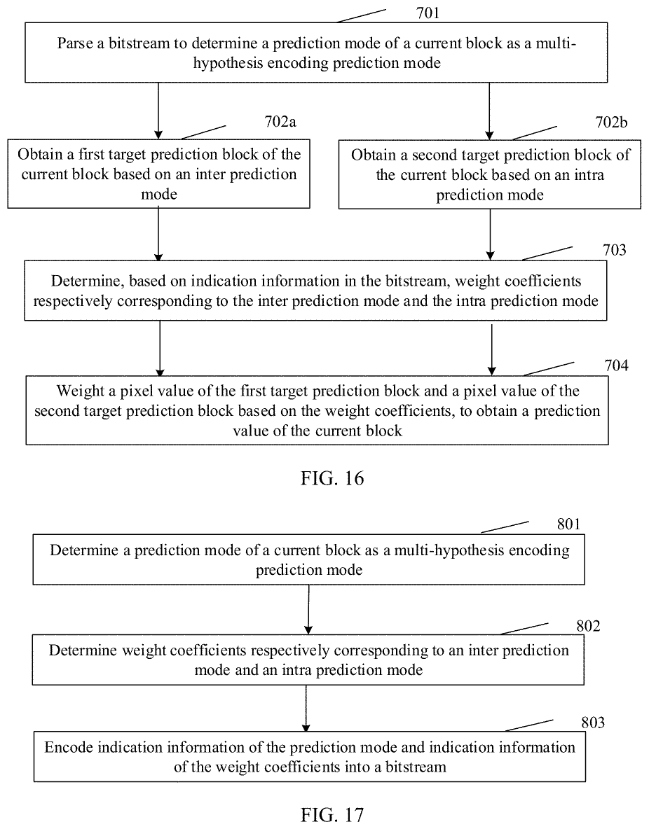

Based on the foregoing description, the following describes, from a perspective of a decoder end, the weighted prediction method for multi-hypothesis encoding provided in the embodiments of the present disclosure. Referring to FIG. 16, the method includes but is not limited to the following operations.

S701. The decoder end parses a bitstream to determine a prediction mode of a to-be-processed picture block (or referred to as a current decoded block or a current block) of a current picture. The prediction mode is, for example, a multi-hypothesis encoding prediction mode with joint intra prediction encoding and inter prediction encoding.

For example, the bitstream may be parsed to obtain a flag of multi-hypothesis encoding with joint intra prediction encoding and inter prediction encoding and a syntax element related to the prediction mode.

For example, the flag of the multi-hypothesis encoding may be mh_intra_flag. When mh_intra_flag (for example, mh_intra_flag is 1) indicates that the multi-hypothesis encoding mode with joint intra prediction encoding and inter prediction encoding is used for current decoding, a syntax element related to an intra encoding mode is parsed out from the bitstream.

In an instance, the syntax element of the intra encoding mode may include a most probable mode flag mh_intra_luma_mpm_flag and a most probable mode index mh_intra_luma_mpm_idx, mh_intra_luma_mpm_flag is used to indicate to perform the intra encoding mode, and mh_intra_luma_mpm_idx represents an index number of an intra candidate list (intra candidate list). The intra prediction mode may be selected from the intra candidate list based on the index number. For example, for a luma component, the intra candidate list may include four modes: a DC mode, a planar mode, a horizontal mode, and a vertical mode. Alternatively, a size of the intra candidate list may be selected based on a shape of the current block, and may include three or four modes. If a width of the current block/CU is twice greater than a height of the current block/CU, the intra candidate list may not include the horizontal mode; or if a height of the current block/CU is twice greater than a width of the current block/CU, the intra candidate list may not include the vertical mode. For a chroma component, a DM mode may be used; in other words, a prediction mode that is the same as that used for the luma component is used.

In another instance, for intra prediction encoding, no index may be transmitted in the bitstream. In this case, a preset mode (for example, the planar mode) may be directly used as the intra encoding mode of the current block.

When the multi-hypothesis encoding mode with joint intra prediction encoding and inter prediction encoding is used for current decoding, an inter prediction mode is determined based on an inter prediction encoding flag. For example, the inter prediction encoding flag may be “merge_flag” used to indicate to perform a merge mode. For another example, in a possible embodiment, the inter prediction encoding flag may be used to indicate to perform an inter MVP mode (for example, an AMVP mode).

It should be noted that the foregoing instances are only used to explain, instead of limiting, the technical solutions of the present disclosure. Neither an intra prediction encoding mode nor an inter prediction encoding mode used in the multi-hypothesis encoding mode with joint intra prediction encoding and inter prediction encoding is limited in the present disclosure.

S702a. The decoder end obtains a first target prediction block of the current block based on the inter prediction mode.

For example, the decoder end may obtain motion information of the current block based on the inter prediction mode of the current block, and perform a motion compensation process based on the motion information of the current block to obtain an inter prediction block. The inter prediction block may be referred to as the first target prediction block of the current block.

For example, if the current block is in the merge mode, a motion information candidate list (merge candidate list) is generated. Then, the motion information of the current block is determined based on an index (a merge index) that is of a merge motion information candidate list and that is carried in the bitstream, and then the inter prediction block of the current block is obtained based on the motion information of the current block.

For another example, if the current block is in the inter MVP mode (for example, the AMVP mode), the motion information of the current block is determined based on an inter prediction direction, a reference index, an index of a motion vector prediction (MVP) value, and a motion vector difference (MVD) that are transmitted in the bitstream, and then the inter prediction block (namely, the first target prediction block) of the current block is obtained based on the motion information of the current block.

It should be noted that, for a related implementation process of the inter prediction mode in this operation, further refer to the detailed description in the foregoing (1). For brevity of the specification, details are not described herein again.

S702b. The decoder end obtains a second target prediction block of the current block based on the intra prediction mode.

For example, the decoder end may obtain motion information of the current block based on the intra prediction mode of the current block, and perform a motion compensation process based on the motion information of the current block to obtain an intra prediction block. The intra prediction block may be referred to as the second target prediction block of the current block.

In an instance, the intra prediction block (namely, the second target prediction block) may be generated based on the intra prediction mode determined based on mh_intra_luma_mpm_flag and mh_intra_luma_mpm_idx.

In another instance, the intra prediction block may be generated based on the intra prediction mode determined based on mh_intra_luma_mpm_flag and mh_intra_luma_mpm_idx, but two intra encoding tools, namely, prediction pixel filtering and/or PDPC, are not used in the intra prediction mode.

In still another instance, the intra encoding mode may be set to the planar mode, and the planar mode is invoked to generate the intra prediction block.

In yet another instance, the intra encoding mode may be set to the planar mode, and the planar mode is invoked to generate the intra prediction block, but two intra encoding tools, namely, prediction pixel filtering and/or PDPC, are not used in the intra prediction mode.

It should be noted that, for the intra prediction mode in this operation, further refer to the detailed description in the foregoing (2). For brevity of the specification, details are not described herein again.

It should be further noted that there is no inevitable sequence between S702a and S702b; in other words, S702a may be performed before S702b, S702a may be performed after S702b, or S702a and S702b may be performed simultaneously. This is not limited in the present disclosure.

S703. The decoder end determines, based on indication information in the bitstream, weight coefficients respectively corresponding to the inter prediction mode and the intra prediction mode.

For example, an encoder end may implicitly or explicitly indicate the weight coefficients respectively corresponding to the inter prediction mode and the intra prediction mode to the decoder end by using the indication information. The encoder may adaptively determine, based on different encoding/decoding scenarios, a weight coefficient combination {Mi, Ni} corresponding to weighted prediction of the current block.

In some embodiments, the indication information includes reference picture queue information, and the reference picture queue information is used to indicate a reference picture queue corresponding to the to-be-processed picture block. The decoder end may determine, based on the reference picture queue information, encoding configuration information corresponding to the to-be-processed picture block, and then the decoder end may determine, based on the encoding configuration information, the weight coefficients respectively corresponding to the inter prediction mode and the intra prediction mode.

In some embodiments, the indication information includes reference picture queue information, and the reference picture queue information is used to indicate a reference picture queue corresponding to the to-be-processed picture block. The encoder end may determine, based on the reference picture queue information, a value minimum Lmin, a value maximum Lmax, or an average value Lavg of closest time-domain distances pocDiffmin of a plurality of reference picture sets corresponding to the to-be-processed picture block. pocDiffmin represents a value minimum in time-domain distances pocDiff between all reference pictures in the reference picture set and the to-be-processed picture block. Then, the decoder end determines, based on Lmin, Lmax, or Lavg, the weight coefficients respectively corresponding to the inter prediction mode and the intra prediction mode.

In some embodiments, the indication information is used to determine an average value Ravg of time-domain distances pocDiffmin between all reference pictures in a preset reference picture set corresponding to the to-be-processed picture block and the to-be-processed picture block. The decoder end determines, based on Ravg, the weight coefficients respectively corresponding to the inter prediction mode and the intra prediction mode.

In some embodiments, the indication information in the bitstream includes preset reference picture set information, and the preset reference picture set information is used to indicate a preset reference picture set in a reference picture queue. The decoder end may determine, based on the preset reference picture set information, POCs of reference pictures in all of a plurality of reference picture sets corresponding to the to-be-processed picture block. Then, the decoder end determines, based on the POCs of the reference pictures respectively corresponding to all the reference picture sets, the weight coefficients respectively corresponding to the inter prediction mode and the intra prediction mode.

In some embodiments, the indication information in the bitstream includes a weight indicator bit of slice header information in the bitstream. The decoder end determines, based on the weight indicator bit of the slice header information, the weight coefficients respectively corresponding to the inter prediction mode and the intra prediction mode.

It should be noted that detailed content of some implementations of adaptively determining the weight coefficient combination {Mi, Ni} corresponding to the weighted prediction of the current block is described above in detail. For brevity of the specification, details are not described herein again.

S704. The decoder end weights a pixel value of the first target prediction block and a pixel value of the second target prediction block based on the weight coefficients respectively corresponding to the inter prediction mode and the intra prediction mode, to obtain a prediction value (prediction picture) of the current block.

For example, in an instance, the pixel value of the first target prediction block and the pixel value of the second target prediction block may be weighted according to formula (6) described above, to obtain the prediction value (prediction picture) of the current block.

In a possible embodiment, if the current block has no residual, the prediction picture is a reconstructed picture of the current block; or if the current block has a residual, residual information and the prediction picture may be subsequently added to obtain a reconstructed picture of the current block.

It may be learned that, in a multi-hypothesis encoding prediction process with joint intra prediction encoding and inter prediction encoding in the embodiments of the present disclosure, the decoder end may parse out the information from the bitstream to adaptively determine, based on different encoding/decoding scenarios, the weight coefficients respectively corresponding to the inter prediction mode and the intra prediction mode, thereby ensuring normal execution of multi-hypothesis encoding in diversified scenarios, and improving picture prediction accuracy and encoding efficiency and performance.

Based on the foregoing description, the following describes, from a perspective of an encoder end, the weighted prediction method for multi-hypothesis encoding provided in the embodiments of the present disclosure. Referring to FIG. 17, the method includes but is not limited to the following operations.

S801. The encoder end determines a prediction mode of a to-be-processed picture block (or referred to as a currently encoded block or a current block) of a current picture. The prediction mode is, for example, a multi-hypothesis encoding prediction mode with joint intra prediction encoding and inter prediction encoding.

For inter prediction on the encoder end, in an embodiment, a plurality of inter prediction modes may be preset. The plurality of inter prediction modes include, for example, the merge mode or the inter MVP mode (for example, the AMVP mode) described above. The encoder end traverses the plurality of inter prediction modes to determine an optimal inter prediction mode for prediction of the current block.

In an embodiment, only one inter prediction mode may be preset; in other words, in this case, the encoder end directly determines that a default inter prediction mode (for example, the merge mode) is currently used.

For intra prediction on the encoder end, in an embodiment, an intra candidate list may be preset. The intra candidate list includes a plurality of intra prediction modes. The encoder end traverses the plurality of intra prediction modes to determine an optimal intra prediction mode for prediction of the current block.

In an embodiment, only one intra prediction mode may be preset; in other words, in this case, the encoder end directly determines that a default intra prediction mode (for example, the planar mode) is currently used.

It should be noted that, for the inter prediction mode, further refer to the detailed description in (1) described above, and for the intra prediction mode, further refer to the detailed description in (2) described above. For brevity of the specification, details are not described herein again.

S802. The encoder end determines weight coefficients respectively corresponding to the inter prediction mode and the intra prediction mode.

In some embodiments, the encoder end may determine, based on encoding configuration information corresponding to the to-be-processed picture block, the weight coefficients respectively corresponding to the inter prediction mode and the intra prediction mode.

In some embodiments, the encoder end may determine, through calculation, a value minimum Lmin, a value maximum Lmax, or an average value Lavg of closest time-domain distances pocDiffmin of a plurality of reference picture sets corresponding to the to-be-processed picture block, and then determine, based on Lmin, Lmax, or Lavg, the weight coefficients respectively corresponding to the inter prediction mode and the intra prediction mode.

In some embodiments, the encoder end may determine, through calculation, an average value Ravg of time-domain distances pocDiffmin between all reference pictures in a preset reference picture set corresponding to the to-be-processed picture block and the to-be-processed picture block, and then determine, based on Ravg, the weight coefficients respectively corresponding to the inter prediction mode and the intra prediction mode.

In some embodiments, the encoder end may determine POCs of reference pictures in all of a plurality of reference picture sets corresponding to the to-be-processed picture block, and then determine, based on the POCs of the reference pictures respectively corresponding to all the reference picture sets, the weight coefficients respectively corresponding to the inter prediction mode and the intra prediction mode.

In some embodiments, the encoder end may determine, according to a preset algorithm, the weight coefficients respectively corresponding to the inter prediction mode and the intra prediction mode. The preset algorithm may be, for example, an RD algorithm or a fast algorithm, or may be another algorithm; and is not limited herein.

It should be noted that detailed content of some implementations of adaptively determining a weight coefficient combination {Mi, Ni} corresponding to the weighted prediction of the current block is described above in detail. For brevity of the specification, details are not described herein again.

S803. The encoder end encodes indication information used to implicitly or explicitly indicate the weight coefficients, a prediction mode flag, a syntax element related to the prediction mode, and the like into a bitstream.

In some embodiments, the indication information is used to determine the encoding configuration information corresponding to the to-be-processed picture block. In some embodiments, the indication information is used to determine the value minimum Lmin, the value maximum Lmax, or the average value Lavg of the closest time-domain distances pocDiffmin of the plurality of reference picture sets corresponding to the to-be-processed picture block. In some embodiments, the indication information is used to determine the average value Ravg of the time-domain distances pocDiffmin between all the reference pictures in the preset reference picture set corresponding to the to-be-processed picture block and the to-be-processed picture block. In some embodiments, the indication information includes a weight indicator bit of slice header information.

It should be noted that the foregoing embodiments describe only a process in which the encoder end implements encoding and bitstream sending. Based on the foregoing description, one of ordinary skilled in the art understands that the encoder end may further implement, in another stage, another method described in the embodiments of the present disclosure. For example, for implementation of a process of reconstructing the current block by the encoder end in the prediction of the current block, refer to the related method described above on the decoder end (as described in the embodiment in FIG. 16). Details are not described herein again.

It may be learned that, in a multi-hypothesis encoding prediction process with joint intra prediction encoding and inter prediction encoding in the embodiments of the present disclosure, the encoder end may adaptively determine, based on different encoding/decoding scenarios, the weight coefficients respectively corresponding to the inter prediction mode and the intra prediction mode, thereby ensuring normal execution of multi-hypothesis encoding in diversified scenarios, and improving picture prediction accuracy and encoding efficiency and performance.

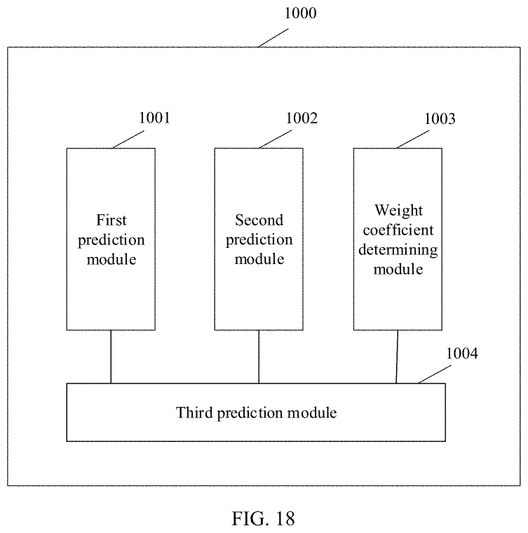

Referring to FIG. 18, based on a same disclosure concept as the foregoing method, an embodiment of the present disclosure further provides a device 1000.

The device 1000 includes a first prediction module 1001, a second prediction module 1002, a weight coefficient determining module 1003, and a third prediction module 1004.

The first prediction module 1001 is configured to determine a first target prediction block of a to-be-processed picture block based on an inter prediction mode.

The second prediction module 1002 is configured to determine a second target prediction block of the to-be-processed picture block based on an intra prediction mode.

The weight coefficient determining module 1003 is configured to determine, based on indication information in a bitstream, weight coefficients respectively corresponding to the inter prediction mode and the intra prediction mode.

The third prediction module 1004 is configured to weight a pixel value of the first target prediction block and a pixel value of the second target prediction block based on the weight coefficients, to obtain a prediction value of the to-be-processed picture block.

For implementation of the first prediction module 1001, the second prediction module 1002, the weight coefficient determining module 1003, and the third prediction module 1004, refer to the related descriptions in FIG. 16, FIG. 17, and the foregoing embodiments. For brevity of the specification, details are not described herein.

The indication information corresponds to different weight coefficient combinations in different cases, and the weight coefficient combination includes the weight coefficients respectively corresponding to the inter prediction mode and the intra prediction mode

In some possible embodiments, the indication information includes reference picture queue information, and the reference picture queue information is used to indicate a reference picture queue corresponding to the to-be-processed picture block.

The weight coefficient determining module 1003 is configured to: determine, based on the reference picture queue information, encoding configuration information corresponding to the to-be-processed picture block; and determine, based on the encoding configuration information corresponding to the to-be-processed picture block, the weight coefficients respectively corresponding to the inter prediction mode and the intra prediction mode.

In some possible embodiments, the weight coefficient determining module 1003 is configured to: when the encoding configuration information corresponding to the to-be-processed picture block represents one of a low delay (Low delay) configuration, a P slice only (P slice only) configuration, or a B slice only (B slice only) configuration, determine that a weight coefficient corresponding to the inter prediction mode is different from a weight coefficient corresponding to the intra prediction mode and the weight coefficient corresponding to the inter prediction mode and the weight coefficient corresponding to the intra prediction mode are M1 and N1.

In some possible embodiments, the weight coefficient corresponding to the inter prediction mode is greater than the weight coefficient corresponding to the intra prediction mode.

In some possible embodiments, the indication information includes reference picture queue information, the reference picture queue information is used to indicate a reference picture queue corresponding to the to-be-processed picture block, the reference picture queue includes at least one reference picture set, and each of the at least one reference picture set includes at least one reference picture.

The weight coefficient determining module 1003 is configured to: determine a time-domain distance between each of the at least one reference picture in each reference picture set and the to-be-processed picture block, and determine a value minimum in a time-domain distance respectively corresponding to the at least one reference picture in each reference picture set as a closest time-domain distance of each reference picture set; and

determine, based on closest time-domain distances of all of the plurality of reference picture sets, the weight coefficients respectively corresponding to the inter prediction mode and the intra prediction mode.

In some possible embodiments, the weight coefficient determining module 1003 is configured to determine, based on a minimum time-domain distance in the closest time-domain distances respectively corresponding to all of the plurality of reference picture sets, the weight coefficients respectively corresponding to the inter prediction mode and the intra prediction mode.

In some possible embodiments, the weight coefficient determining module 1003 is configured to: when the minimum time-domain distance in the closest time-domain distances respectively corresponding to all the reference picture sets is less than or equal to a first preset value, set the weight coefficients respectively corresponding to the inter prediction mode and the intra prediction mode to M1 and N1 respectively; or

when the minimum time-domain distance in the closest time-domain distances respectively corresponding to all the reference picture sets is greater than the first preset value and is less than or equal to a second preset value, set the weight coefficients respectively corresponding to the inter prediction mode and the intra prediction mode to M2 and N2 respectively.

The first preset value is less than the second preset value, a ratio of M1 to N1 is less than a ratio of M2 to N2, and M1, M2, N1, and N2 are positive integers.

In some possible embodiments, the weight coefficient determining module 1003 is configured to determine, based on a maximum time-domain distance in the closest time-domain distances respectively corresponding to all the reference picture sets, the weight coefficients respectively corresponding to the inter prediction mode and the intra prediction mode.

In some possible embodiments, the weight coefficient determining module 1003 is configured to: when the maximum time-domain distance in the closest time-domain distances respectively corresponding to all the reference picture sets is less than or equal to a first preset value, set the weight coefficients respectively corresponding to the inter prediction mode and the intra prediction mode to M1 and N1 respectively; or

when the maximum time-domain distance in the closest time-domain distances respectively corresponding to all the reference picture sets is greater than the first preset value and is less than or equal to a second preset value, set the weight coefficients respectively corresponding to the inter prediction mode and the intra prediction mode to M2 and N2 respectively.

The first preset value is less than the second preset value, a ratio of M1 to N1 is less than a ratio of M2 to N2, and M1, M2, N1, and N2 are positive integers.

In some possible embodiments, the weight coefficient determining module 1003 is configured to determine, based on an average value of the closest time-domain distances respectively corresponding to all the reference picture sets, the weight coefficients respectively corresponding to the inter prediction mode and the intra prediction mode.

In some possible embodiments, the weight coefficient determining module 1003 is configured to: when the average value of the closest time-domain distances respectively corresponding to all the reference picture sets is less than or equal to a first preset value, set the weight coefficients respectively corresponding to the inter prediction mode and the intra prediction mode to M1 and N1 respectively; or

when the average value of the closest time-domain distances respectively corresponding to all the reference picture sets is greater than the first preset value and is less than or equal to a second preset value, set the weight coefficients respectively corresponding to the inter prediction mode and the intra prediction mode to M2 and N2 respectively.

The first preset value is less than the second preset value, a ratio of M1 to N1 is less than a ratio of M2 to N2, and M1, M2, N1, and N2 are positive integers.

In some possible embodiments, the indication information includes preset reference picture set information, and the preset reference picture set information is used to indicate a preset reference picture set in a reference picture queue.

The weight coefficient determining module 1003 is configured to: determine a time-domain distance between each reference picture in the preset reference picture set and the to-be-processed picture block; and determine, based on an average value of time-domain distances respectively corresponding to all reference pictures, the weight coefficients respectively corresponding to the inter prediction mode and the intra prediction mode.

In some possible embodiments, the weight coefficient determining module 1003 is configured to: when the average value of the time-domain distances respectively corresponding to all the reference pictures is less than or equal to a first preset value, set the weight coefficients respectively corresponding to the inter prediction mode and the intra prediction mode to M1 and N1 respectively; or

when the average value of the time-domain distances respectively corresponding to all the reference picture sets is greater than the first preset value and is less than or equal to a second preset value, set the weight coefficients respectively corresponding to the inter prediction mode and the intra prediction mode to M2 and N2 respectively.

The first preset value is less than the second preset value, a ratio of M1 to N1 is less than a ratio of M2 to N2, and M1, M2, N1, and N2 are positive integers.

In some possible embodiments, the indication information in the bitstream includes reference picture queue information, the reference picture queue information is used to indicate a reference picture queue corresponding to the to-be-processed picture block, the reference picture queue includes at least one reference picture set, and each of the at least one reference picture set includes at least one reference picture.

The weight coefficient determining module 1003 is configured to: determine a picture order count (POC) of each reference picture in any reference picture set; and

determine, based on POCs of reference pictures respectively corresponding to all reference picture sets, the weight coefficients respectively corresponding to the inter prediction mode and the intra prediction mode.

In some possible embodiments, the weight coefficient determining module 1003 is configured to: when the plurality of reference picture sets each include only one reference picture, all reference pictures have a same POC, and the reference pictures with the same POC are located before the to-be-processed picture block in time domain, set the weight coefficients respectively corresponding to the inter prediction mode and the intra prediction mode to M1 and N1 respectively; or

in a case other than the case, set the weight coefficients respectively corresponding to the inter prediction mode and the intra prediction mode to M2 and N2 respectively.

A ratio of M1 to N1 is less than a ratio of M2 to N2, and M1, M2, N1, and N2 are positive integers.

In some possible embodiments, the weight coefficient determining module 1003 is configured to: when the plurality of reference picture sets include reference pictures with different POCs and all reference pictures in all the reference picture sets are located before the to-be-processed picture block in time domain, set the weight coefficients respectively corresponding to the inter prediction mode and the intra prediction mode to M2 and N2 respectively; or

in a case other than the case, set the weight coefficients respectively corresponding to the inter prediction mode and the intra prediction mode to M1 and N1 respectively.

A ratio of M1 to N1 is less than a ratio of M2 to N2, and M1, M2, N1, and N2 are positive integers.

In some possible embodiments, the indication information in the bitstream includes a weight indicator bit of slice header information in the bitstream.

The weight coefficient determining module 1003 is configured to determine, based on the weight indicator bit of the slice header information, the weight coefficients respectively corresponding to the inter prediction mode and the intra prediction mode.

In some possible embodiments, the weight coefficient determining module 1003 is configured to: when the weight indicator bit of the slice header information is a first indication value, set the weight coefficients respectively corresponding to the inter prediction mode and the intra prediction mode to M1 and N1 respectively; or

when the weight indicator bit of the slice header information is a second indication value, set the weight coefficients respectively corresponding to the inter prediction mode and the intra prediction mode to M2 and N2 respectively.

A ratio of M1 to N1 is less than a ratio of M2 to N2, and M1, M2, N1, and N2 are positive integers.

In some possible embodiments, the weight coefficient determining module 1003 is configured to: when the weight indicator bit of the slice header information is a first indication value, respectively determine a weight coefficient corresponding to the inter prediction mode and a weight coefficient corresponding to the intra prediction mode from a first set and a second set based on the first indication value; or

when the weight indicator bit of the slice header information is a second indication value, respectively determine a weight coefficient corresponding to the inter prediction mode and a weight coefficient corresponding to the intra prediction mode from a first set and a second set based on the second indication value.

A ratio of the weight coefficient that is of the inter prediction mode and that is determined based on the first indication value to the weight coefficient that is of the intra prediction mode and that is determined based on the first indication value is less than a ratio of the weight coefficient that is of the inter prediction mode and that is determined based on the second indication value to the weight coefficient that is of the intra prediction mode and that is determined based on the second indication value.

In some possible embodiments, when the plurality of reference picture sets include reference pictures with different POCs and all reference pictures in all the reference picture sets are located before the to-be-processed picture block in time domain, the first set includes M1 and M2, and the second set includes N1 and N2; or

in a case other than the case, the first set includes M3 and M4, and the second set includes N3 and N4.

A ratio of M1 to N1 is less than a ratio of M3 to N3, a ratio of M2 to N2 is less than a ratio of M4 to N4, and M1, M2, M3, M4, N1, N2, N3, and N4 are positive integers.

In some possible embodiments, the indication information in the bitstream includes a weight indicator bit of largest coding unit (LCU) information in the bitstream.

The weight coefficient determining module 1003 is configured to determine, based on the weight indicator bit of the LCU information, the weight coefficients respectively corresponding to the inter prediction mode and the intra prediction mode.

In some possible embodiments, the weight coefficient determining module 1003 is configured to: when the weight indicator bit of the LCU information is a third indication value, set the weight coefficients respectively corresponding to the inter prediction mode and the intra prediction mode to M1 and N1 respectively; or

when the weight indicator bit of the LCU information is a fourth indication value, set the weight coefficients respectively corresponding to the inter prediction mode and the intra prediction mode to M2 and N2 respectively.

A ratio of M1 to N1 is less than a ratio of M2 to N2, and M1, M2, N1, and N2 are positive integers.

In some possible embodiments, the weight coefficient determining module 1003 is configured to: when the weight indicator bit of the LCU information is a third indication value, respectively determine a weight coefficient corresponding to the inter prediction mode and a weight coefficient corresponding to the intra prediction mode from a third set and a fourth set based on the third indication value; or

when the weight indicator bit of the LCU information is a fourth indication value, respectively determine a weight coefficient corresponding to the inter prediction mode and a weight coefficient corresponding to the intra prediction mode from a third set and a fourth set based on the fourth indication value.

A ratio of the weight coefficient that is of the inter prediction mode and that is determined based on the third indication value to the weight coefficient that is of the intra prediction mode and that is determined based on the third indication value is less than a ratio of the weight coefficient that is of the inter prediction mode and that is determined based on the fourth indication value to the weight coefficient that is of the intra prediction mode and that is determined based on the fourth indication value.

In some possible embodiments, when the plurality of reference picture sets include reference pictures with different POCs and all reference pictures in all the reference picture sets are located before the to-be-processed picture block in time domain, the third set includes M1 and M2, and the fourth set includes N1 and N2; or

in a case other than the case, the third set includes M3 and M4, and the fourth set includes N3 and N4.

A ratio of M1 to N1 is less than a ratio of M3 to N3, a ratio of M2 to N2 is less than a ratio of M4 to N4, and M1, M2, M3, M4, N1, N2, N3, and N4 are positive integers.

In some possible embodiments, the indication information in the bitstream further includes a weight indicator bit of slice header information in the bitstream; and when the weight indicator bit of the slice header information is a first indication value, the third set includes M1 and M2, and the fourth set includes N1 and N2; or

when the weight indicator bit of the slice header information is a second indication value, the third set includes M3 and M4, and the fourth set includes N3 and N4.

A ratio of M1 to N1 is less than a ratio of M3 to N3, a ratio of M2 to N2 is less than a ratio of M4 to N4, and M1, M2, M3, M4, N1, N2, N3, and N4 are positive integers.

In some possible embodiments, the indication information in the bitstream includes a weight indicator bit of slice header information and a weight indicator bit of coding unit (CU) information in the bitstream.

The weight coefficient determining module 1003 is configured to: determine, based on the weight indicator bit of the slice header information, weight coefficient sets respectively corresponding to the inter prediction mode and the intra prediction mode; and respectively determine the weight coefficients respectively corresponding to the inter prediction mode and the intra prediction mode from the weight coefficient sets based on the weight indicator bit of the CU information.

In some possible embodiments, a weight coefficient set corresponding to the inter prediction mode and a weight coefficient set corresponding to the intra prediction mode are respectively determined as a fifth set and a sixth set based on the weight indicator bit of the slice header information.

The weight coefficient determining module 1003 is configured to: when the weight indicator bit of the CU information is a fifth indication value, respectively determine the weight coefficient corresponding to the inter prediction mode and the weight coefficient corresponding to the intra prediction mode from the fifth set and the sixth set based on the fifth indication value; or

when the weight indicator bit of the CU information is a sixth indication value, respectively determine the weight coefficient corresponding to the inter prediction mode and the weight coefficient corresponding to the intra prediction mode from the fifth set and the sixth set based on the sixth indication value.

A ratio of the weight coefficient that is of the inter prediction mode and that is determined based on the fifth indication value to the weight coefficient that is of the intra prediction mode and that is determined based on the fifth indication value is less than a ratio of the weight coefficient that is of the inter prediction mode and that is determined based on the sixth indication value to the weight coefficient that is of the intra prediction mode and that is determined based on the sixth indication value.

In some possible embodiments, the indication information in the bitstream further includes the weight indicator bit of the slice header information in the bitstream; and

when the weight indicator bit of the slice header information is a first indication value, the fifth set includes M1 and M2, and the sixth set includes N1 and N2; or when the weight indicator bit of the slice header information is a second indication value, the fifth set includes M3 and M4, and the sixth set includes N3 and N4.

A ratio of M1 to N1 is less than a ratio of M3 to N3, a ratio of M2 to N2 is less than a ratio of M4 to N4, and M1, M2, M3, M4, N1, N2, N3, and N4 are positive integers.

In some possible embodiments, the inter prediction mode is a merge (Merge) mode.

In some possible embodiments, the intra prediction mode is a planar (Planar) mode.

It should be noted that, for implementation of the first prediction module 1001, the second prediction module 1002, the weight coefficient determining module 1003, and the third prediction module 1004, refer to the related descriptions in FIG. 16, FIG. 17, and the foregoing embodiments. For brevity of the specification, details are not described herein.

One of ordinary skilled in the art can appreciate that functions described with reference to various illustrative logical blocks, modules, and algorithm operations disclosed in this specification may be implemented by using hardware, software, firmware, or any combination thereof. If the functions are implemented by using software, the functions described with reference to the various illustrative logical blocks, modules, and operations may be stored in or transmitted by a computer readable medium as one or more instructions or code, and executed by a hardware-based processing unit. The computer readable medium may include a computer readable storage medium. The computer readable storage medium corresponds to a tangible medium such as a data storage medium, or a communications medium including any medium that facilitates transmission of a computer program from a place to another place (according to, for example, a communication protocol). In this manner, the computer readable medium may substantially correspond to (1) a non-transitory tangible computer readable storage medium, or (2) a communication medium, such as a signal or carrier. The data storage medium may be any available medium accessible to one or more computers or one or more processors to retrieve instructions, code, and/or data structures for implementing the technologies described in the present disclosure. A computer program product may include a computer readable medium.

By way of example and not limitation, such computer readable storage media may include a RAM, a ROM, an EEPROM, a CD-ROM or another optical disk storage apparatus, a magnetic disk storage apparatus or another magnetic storage apparatus, a flash memory, or any other media that is available to store desired program code in a form of an instruction or a data structure and accessible to a computer. In addition, any connection is appropriately referred to as a computer readable medium. For example, if an instruction is transmitted from a website, a server, or another remote source by using a coaxial cable, an optical fiber, a twisted pair, a digital subscriber line (DSL), or wireless technologies such as infrared, radio, and microwave, the coaxial cable, the optical fiber, the twisted pair, the DSL, or the wireless technologies such as infrared, radio, and microwave are included in the definition of medium. However, it should be understood that the computer readable storage medium and the data storage medium do not include connections, carriers, signals, or other transitory media, but are actually directed to non-transitory tangible storage media. As used herein, a magnetic disk and an optical disc include a compact disc (CD), a laser disc, an optical disc, a digital versatile disc (DVD), and a Blu-ray disc. The magnetic disk typically reproduces data magnetically, and the optical disc reproduces data optically by using a laser. A combination of the foregoing items shall also be included in the scope of the computer readable medium.

An instruction may be executed by one or more processors such as one or more digital signal processors (DSP), general purpose microprocessors, application-specific integrated circuits (ASIC), field-programmable gate arrays (FPGA), or other equivalent integrated circuits or discrete logic circuits. Therefore, the term “processor” used in this specification may be the foregoing structure, or any other structure appropriate to implement the technologies described in this specification. Further, in an embodiment, the functions described with reference to the various illustrative logical blocks, modules, and operations described in this specification may be provided within dedicated hardware and/or software modules configured for encoding and decoding, or incorporated in a combined encoder/decoder. In addition, the technologies may be completely implemented in one or more circuits or logic elements.

The technologies in the present disclosure may be implemented in various apparatuses or devices, including a wireless handset, an integrated circuit (IC), or a group of ICs (for example, a chipset). In the present disclosure, various components, modules, or units are described to emphasize functions of an apparatus configured to implement the disclosed technologies, but the functions are unnecessarily implemented by using different hardware units. Actually, as described above, various units may be combined into an encoder/decoder hardware unit in combination with appropriate software and/or firmware, or may be provided by using interoperable hardware units (including one or more processors described above).

In the foregoing embodiments, the descriptions of the embodiments have respective focuses. For a part that is not described in detail in an embodiment, refer to related descriptions in other embodiments.

The foregoing descriptions are merely embodiments of the present disclosure, but are not intended to limit the protection scope of the present disclosure. Any variation or replacement readily figured out by one of ordinary skilled in the art within the technical scope disclosed in the present disclosure shall fall within the protection scope of the present disclosure. Therefore, the protection scope of the present disclosure shall be subject to the protection scope of the claims.

1. A weighted prediction method for multi-hypothesis encoding, comprising:
determining a first target prediction block of a picture block to be processed based on an inter prediction mode;
determining a second target prediction block of the picture block based on an intra prediction mode;
determining, based on indication information in a bitstream, weight coefficients respectively corresponding to the inter prediction mode and the intra prediction mode; and
obtaining a prediction value of the picture block by weighting a first pixel value of the first target prediction block and a second pixel value of the second target prediction block based on the weight coefficients.

2. The method according to claim 1, wherein the indication information corresponds to different weight coefficient combinations in different cases, and wherein the weight coefficient combination comprises the weight coefficients respectively corresponding to the inter prediction mode and the intra prediction mode.

3. The method according to claim 1, wherein the indication information comprises reference picture queue information used to indicate a reference picture queue corresponding to the picture block; and wherein the determining weight coefficients respectively corresponding to the inter prediction mode and the intra prediction mode comprises:
determining, based on the reference picture queue information, encoding configuration information corresponding to the picture block; and
determining, based on the encoding configuration information corresponding to the picture block, the weight coefficients respectively corresponding to the inter prediction mode and the intra prediction mode.

4. The method according to claim 3, wherein the determining the weight coefficients respectively corresponding to the inter prediction mode and the intra prediction mode comprises:
when the encoding configuration information corresponding to the picture block represents one of a low delay configuration, a P slice only configuration, or a B slice only configuration, determining the weight coefficients corresponding to the inter prediction mode and the intra prediction mode as M1 and N1 respectively, wherein M1 is not equal to N1.

5. The method according to claim 1, wherein the indication information in the bitstream comprises a weight indicator bit of slice header information in the bitstream; and
correspondingly, the determining weight coefficients respectively corresponding to the inter prediction mode and the intra prediction mode comprises:
determining, based on the weight indicator bit of the slice header information, the weight coefficients respectively corresponding to the inter prediction mode and the intra prediction mode.

6. The method according to claim 5, wherein the determining the weight coefficients respectively corresponding to the inter prediction mode and the intra prediction mode comprises:
when the weight indicator bit of the slice header information is a first indication value, determining the weight coefficients respectively corresponding to the inter prediction mode and the intra prediction mode as M1 and N1 respectively; or
when the weight indicator bit of the slice header information is a second indication value, determining the weight coefficients respectively corresponding to the inter prediction mode and the intra prediction mode as M2 and N2 respectively, wherein
a ratio of M1 to N1 is less than a ratio of M2 to N2, and M1, M2, N1, and N2 are positive integers.

7. The method according to claim 1, wherein the indication information in the bitstream comprises a weight indicator bit of largest coding unit (LCU) information in the bitstream; and wherein
correspondingly, the determining weight coefficients respectively corresponding to the inter prediction mode and the intra prediction mode comprises:
determining, based on the weight indicator bit of the LCU information, the weight coefficients respectively corresponding to the inter prediction mode and the intra prediction mode.

8. The method according to claim 7, wherein the determining the weight coefficients respectively corresponding to the inter prediction mode and the intra prediction mode comprises:
when the weight indicator bit of the LCU information is a third indication value, setting the weight coefficients respectively corresponding to the inter prediction mode and the intra prediction mode to M1 and N1 respectively; or
when the weight indicator bit of the LCU information is a fourth indication value, setting the weight coefficients respectively corresponding to the inter prediction mode and the intra prediction mode to M2 and N2 respectively, wherein
a ratio of M1 to N1 is less than a ratio of M2 to N2, and M1, M2, N1, and N2 are positive integers.

9. The method according to claim 1, wherein the indication information in the bitstream comprises a weight indicator bit of slice header information and a weight indicator bit of coding unit (CU) information in the bitstream; and wherein
correspondingly, the determining weight coefficients respectively corresponding to the inter prediction mode and the intra prediction mode comprises:
determining, based on the weight indicator bit of the slice header information, weight coefficient sets respectively corresponding to the inter prediction mode and the intra prediction mode; and
respectively determining the weight coefficients respectively corresponding to the inter prediction mode and the intra prediction mode from the weight coefficient sets based on the weight indicator bit of the CU information.

10. The method according to claim 9, wherein a weight coefficient set corresponding to the inter prediction mode and a weight coefficient set corresponding to the intra prediction mode are respectively determined as a fifth set and a sixth set based on the weight indicator bit of the slice header information; and wherein
the determining the weight coefficients respectively corresponding to the inter prediction mode and the intra prediction mode comprises:
when the weight indicator bit of the CU information is a fifth indication value, respectively determining a weight coefficient corresponding to the inter prediction mode and a weight coefficient corresponding to the intra prediction mode from the fifth set and the sixth set based on the fifth indication value; or
when the weight indicator bit of the CU information is a sixth indication value, respectively determining a weight coefficient corresponding to the inter prediction mode and a weight coefficient corresponding to the intra prediction mode from the fifth set and the sixth set based on the sixth indication value, wherein
a ratio of the weight coefficient of the inter prediction mode determined based on the fifth indication value to the weight coefficient of the intra prediction mode determined based on the fifth indication value is less than a ratio of the weight coefficient of the inter prediction mode determined based on the sixth indication value to the weight coefficient of the intra prediction mode determined based on the sixth indication value.

11. The method according to claim 10, wherein the indication information in the bitstream further comprises the weight indicator bit of the slice header information in the bitstream; and wherein
when the weight indicator bit of the slice header information is a first indication value, the fifth set comprises M1 and M2, and the sixth set comprises N1 and N2; or
when the weight indicator bit of the slice header information is a second indication value, the fifth set comprises M3 and M4, and the sixth set comprises N3 and N4, wherein
a ratio of M1 to N1 is less than a ratio of M3 to N3, a ratio of M2 to N2 is less than a ratio of M4 to N4, and M1, M2, M3, M4, N1, N2, N3, and N4 are positive integers.

12. The method according to claim 1, wherein the inter prediction mode is a merge mode.

13. The method according to claim 1, wherein the intra prediction mode is a planar mode.

14. An apparatus, comprising:
a first prediction module, configured to determine a first target prediction block of a picture block to be processed based on an inter prediction mode;
a second prediction module, configured to determine a second target prediction block of the picture block based on an intra prediction mode;
a weight coefficient determining module, configured to determine, based on indication information in a bitstream, weight coefficients respectively corresponding to the inter prediction mode and the intra prediction mode; and
a third prediction module, configured to weight a first pixel value of the first target prediction block and a second pixel value of the second target prediction block based on the weight coefficients, to obtain a prediction value of the picture block.

15. The apparatus according to claim 14, wherein the indication information corresponds to different weight coefficient combinations in different cases, and wherein the weight coefficient combination comprises the weight coefficients respectively corresponding to the inter prediction mode and the intra prediction mode.

16. The apparatus according to claim 14, wherein the indication information comprises reference picture queue information, wherein the reference picture queue information is used to indicate a reference picture queue corresponding to the picture block; and wherein
the weight coefficient determining module is configured to:
determine, based on the reference picture queue information, encoding configuration information corresponding to the picture block; and
determine, based on the encoding configuration information corresponding to the picture block, the weight coefficients respectively corresponding to the inter prediction mode and the intra prediction mode.

17. The apparatus according to claim 14, wherein the indication information in the bitstream comprises a weight indicator bit of slice header information and a weight indicator bit of encoding unit (CU) information in the bitstream; and wherein
the weight coefficient determining module is configured to:
determine, based on the weight indicator bit of the slice header information, weight coefficient sets respectively corresponding to the inter prediction mode and the intra prediction mode; and
respectively determine the weight coefficients respectively corresponding to the inter prediction mode and the intra prediction mode from the weight coefficient sets based on the weight indicator bit of the CU information.

18. The apparatus according to claim 17, wherein a weight coefficient set corresponding to the inter prediction mode and a weight coefficient set corresponding to the intra prediction mode are respectively determined as a fifth set and a sixth set based on the weight indicator bit of the slice header information; and wherein
the weight coefficient determining module is configured to:
when the weight indicator bit of the CU information is a fifth indication value, respectively determine a weight coefficient corresponding to the inter prediction mode and a weight coefficient corresponding to the intra prediction mode from the fifth set and the sixth set based on the fifth indication value; or
when the weight indicator bit of the CU information is a sixth indication value, respectively determine a weight coefficient corresponding to the inter prediction mode and a weight coefficient corresponding to the intra prediction mode from the fifth set and the sixth set based on the sixth indication value, wherein
a ratio of the weight coefficient that is of the inter prediction mode and that is determined based on the fifth indication value to the weight coefficient of the intra prediction mode determined based on the fifth indication value is less than a ratio of the weight coefficient of the inter prediction mode determined based on the sixth indication value to the weight coefficient of the intra prediction mode determined based on the sixth indication value.

19. The apparatus according to claim 14, wherein the inter prediction mode is a merge mode; or,
the intra prediction mode is a planar mode.

20. A video decoding device, comprising:
a processor, and
a nonvolatile memory coupled to the processor to store instructions, which when executed by the processor, cause the processor to perform operations, the operations comprising:
determining a first target prediction block of a picture block to be processed based on an inter prediction mode;
determining a second target prediction block of the picture block based on an intra prediction mode;
determining, based on indication information in a bitstream, weight coefficients respectively corresponding to the inter prediction mode and the intra prediction mode; and
obtaining a prediction value of the picture block by weighting a first pixel value of the first target prediction block and a second pixel value of the second target prediction block based on the weight coefficients.
